(19) United States
(12) Patent Application Publication
(10) Pub. No.: US 2026/0025264 A1
(43) Pub. Date: Jan. 22, 2026

(54) CONFIDENTIAL COMPUTATION SYSTEM AND CONFIDENTIAL COMPUTATION METHOD

(71) Applicant: Hitachi, Ltd., Tokyo (JP)

(72) Inventors: Masayuki YOSHINO, Tokyo (JP); Hisayoshi SATO, Tokyo (JP); Hirotomo SHINOKI, Tokyo (JP); Kyohei YAMAMOTO, Tokyo (JP)

(21) Appl. No.: 19/262,205

(22) Filed: Jul. 8, 2025

(30) Foreign Application Priority Data
Jul. 18, 2024 (JP) 2024-114960

(51) Int. Cl. H04L 9/08; G06F 21/62

(52) U.S. Cl. CPC H04L 9/085; G06F 21/6209; H04L 9/0861

(57) ABSTRACT

The registration machine is configured to derive a data key by using a plaintext word representing a word which is not encrypted, create encrypted data obtained by encrypting, by using the derived data key, plaintext data representing data which is not encrypted, distribute the data key to a plurality of shares, and encrypt the plaintext word and the shares with searchable encryption to create an encrypted word. The analyzer is configured to encrypt, with the searchable encryption, a plaintext query representing a query which is not encrypted to create an encrypted query. The provision server is configured to acquire the created encrypted word and the created encrypted data to register the encrypted word and the created encrypted data in a database, acquire the created encrypted query to compare the created encrypted query with the registered encrypted word, and acquire the shares if a comparison result indicates a match.

### CROSS-REFERENCE TO RELATED APPLICATION

The present application claims priority from Japanese application JP2024-114960, filed on Jul. 18, 2024, the content of which is hereby incorporated by reference into this application.

### BACKGROUND OF THE INVENTION

### 1. Field of the Invention

The present invention relates to a technology for performing confidential computation.

### 2. Description of Related Art

A so-called cloud computing technology has many advantages, and thus is widely used for various applications today, the cloud computing technology providing, to a user via a network mainly including the Internet, computer resources including a plurality of computers, servers, and the like connected to each other via the network so as to be capable of performing data communication with each other via the network.

However, the cloud computing technology has a risk of information leakage in use due to nature of the cloud computing technology. Therefore, today, for example, in a case where various types of computation are performed in a computer system (hereinafter, also referred to as a “cloud computing system”) constructed on a cloud infrastructure based on the cloud computing technology, various technologies have been proposed in which computation can be executed in a state where information is kept confidential by an encryption technology (for example, NPLs 1 to 2).

### CITATION LIST

### Non Patent Literature

NPL 1: Reza Curtmola, Juan A. Garay, Seny Kamara, Rafail Ostrovsky: Searchable Symmetric encryption: Improved definitions and efficient constructions. J. Computer. Security. 19(5):895 to 934(2011).
NPL 2: Raluca Ada Popa, Catherine M. S. Redfield, Nickolai Zeldovich, and Hari Balakrishnan. CryptDB. Protecting Confidentiality with Encrypted Query Processing. In Proceedings of the 23rd ACM Symposium on Operating Systems Principles (2011).

### SUMMARY OF THE INVENTION

NPL 1 describes a technology capable of searching for data in an encrypted state. However, the application of this technology described in NPL 1 is limited to searching for the encrypted data. Therefore, even if the technology described in NPL 1 is used, other advanced computation cannot be executed on a cloud.

NPL 2 describes a technology capable of extracting a data key for decrypting encrypted data corresponding to a search result if it is determined that the search result is a hit (corresponds to the search). However, in this technology described in NPL 2, data is multi-encrypted in advance, and even after decryption, an encrypted state where only a special operation can be performed cannot be released. Therefore, even when the technology described in NPL 2 is used, computation that can be performed on a cloud is significantly limited, and if an attempt is made to avoid this situation, a plaintext is disclosed more than necessary, and thus information leakage may be caused.

The invention has been made in view of the above problems, and an object of the invention is to provide a technology capable of performing various types of computation on data representing encrypted information in a state where confidentiality of the encrypted information is secured without disclosing a plaintext more than necessary.

A confidential computation system according to the invention is a system that executes computation related to data representing information in a state where the information is kept confidential by encryption, and includes a registration machine, an analyzer, and a provision server, each of which is a computer at least having a processor and a storage device, and which are connected to each other via a network to be capable of performing data communication. The registration machine is configured to derive a data key by using a plaintext word representing a word which is not encrypted, create encrypted data obtained by encrypting, by using the derived data key, plaintext data representing data which is not encrypted, distribute the data key to a plurality of shares, and encrypt the plaintext word and the shares with searchable encryption to create an encrypted word. The analyzer is configured to encrypt, with the searchable encryption, a plaintext query representing a query which is not encrypted to create an encrypted query. The provision server is configured to acquire the created encrypted word and the created encrypted data to register the encrypted word and the created encrypted data in a database, acquire the created encrypted query to compare the created encrypted query with the registered encrypted word, and acquire the shares if a comparison result indicates a match, reconstruct, if the number of the acquired shares is a certain number or more, the data key having a correspondence relationship with the plurality of shares including the certain number or more of the shares by using the certain number or more of the shares, and decrypt the encrypted data into the plaintext data by using the reconstructed data key.

In addition, other problems disclosed by the present application and methods for solving the problems will be made clear by the section of the embodiments for carrying out the invention and the drawings.

According to the invention, various types of computation can be performed on data representing encrypted information in a state where confidentiality of the encrypted information is secured without disclosing a plaintext more than necessary.

### BRIEF DESCRIPTION OF THE DRAWINGS

FIG. 1 is a diagram illustrating an example of a configuration of an entire system including a confidential computation system according to each of Embodiments 1 to 2;

FIG. 2 is a diagram illustrating an example of hardware structures of various devices constituting the confidential computation system;

FIG. 3 is a diagram illustrating an example of functional blocks of various devices constituting the confidential computation system according to each of Embodiments 1 to 2;

FIG. 4 is a sequence diagram illustrating an example of an overall flow of processing executed by the confidential computation system according to each of Embodiments 1 to 2;

FIG. 5A is a diagram illustrating a configuration example of a medical treatment table stored in a database in a provision server according to Embodiment 1;

FIG. 5B is a diagram illustrating, as a comparative example, a configuration of a medical treatment table when all encrypted texts are displayed in plaintexts;

FIG. 6 is a flowchart illustrating an example of a procedure in which a registration machine registers a set of a plaintext word and plaintext data in a registration phase of a confidential computation system according to each of Embodiments 1 to 3;

FIG. 7 is a diagram illustrating an image of a procedure in which a registration machine 100 registers the set of the plaintext word and the plaintext data in the registration phase of the confidential computation system according to each of Embodiments 1 to 3;

FIG. 8 is a flowchart illustrating an example of a procedure in which an analyzer requests a search for one plaintext query in a search phase of the confidential computation system according to each of Embodiments 1 to 3;

FIG. 9 is a flowchart illustrating an example of a procedure in which the provision server is requested by the analyzer to search for one encrypted query and transmits a search result in the search phase of the confidential computation system according to each of Embodiments 1 to 2;

FIG. 10 is a diagram illustrating an image of the procedure in which the provision server is requested by the analyzer to search for one encrypted query and transmits the search result in the search phase of the confidential computation system according to each of Embodiments 1 to 2;

FIG. 11A is a diagram illustrating a configuration example of a medical treatment table stored in a database in each of provision servers according to Embodiments 2 to 3 (when all the encrypted texts are displayed in plaintexts);

FIG. 11B is a diagram illustrating a configuration example of a nursing care table stored in the database in each of the provision servers according to Embodiments 2 to 3 (when all the encrypted texts are displayed in plaintexts);

FIG. 12 is a flowchart illustrating an example of a procedure in which the provision server compares one encrypted query with a search index in a plurality of designated tables and transmits output data in the search phase of the confidential computation system according to Embodiment 2;

FIG. 13 is a diagram illustrating an image of processing in which the provision server compares one encrypted query with a search index of the medical treatment table and the nursing care table and decrypts plaintext data PD in the search phase of the confidential computation system according to Embodiment 2;

FIG. 14 is a diagram illustrating an example of the configuration of the entire system including the confidential computation system according to Embodiment 3;

FIG. 15 is a diagram illustrating an example of functional blocks of various devices constituting the confidential computation system according to Embodiment 3;

FIG. 16 is a sequence diagram illustrating an example of an overall flow of processing executed by the confidential computation system according to Embodiment 3; and

FIG. 17 is a sequence diagram illustrating an example of a procedure in which the provision server is requested to search for one encrypted query and transmits a search result in cooperation with a DB server in a search phase of the confidential computation system according to Embodiment 3.

### DESCRIPTION OF EMBODIMENTS

Hereinafter, various embodiments of the invention will be described in detail with reference to the drawings. However, the invention is not limited to the description of the following embodiments. Examples in which specific configurations are modified without departing from the spirit and scope of the invention are also included. For example, the following embodiments describe the invention in detail, and are not necessarily limited to those including all the configurations included in the description.

In a configuration of the invention described below, the same parts and/or elements, or parts and/or elements having the same functions are denoted by the same reference numerals in different drawings, and redundant descriptions thereof may be omitted.

In addition, in a case where there are a plurality of the same parts and/or elements or parts and/or elements having the same functions, in order to distinguish the plurality of parts and/or elements, different suffixes may be added to the same reference numerals to perform the description. On the other hand, when there is no need to distinguish the plurality of parts and/or elements, the suffixes may be omitted to perform the description.

The notations “first”, “second”, “third”, or the like in the present specification are assigned to identify the components and do not necessarily limit the number, the order, or the content thereof. In addition, a number for identifying a component is used for each context, and the number used in one context does not necessarily indicate the same configuration in another context. In addition, this does not prevent a component identified by a certain number from also having a function of a component identified by another number.

In order to facilitate understanding of the invention, a position, a size, a shape, a range, and the like of each configuration described in the present specification and/or illustrated in the drawings may not represent an actual position, size, shape, range, and the like. Therefore, the invention is not necessarily limited to the position, the size, the shape, the range, or the like disclosed in the present specification and/or the drawings.

In the present specification, a component represented in a single form includes a plurality of forms unless otherwise clearly described in the context.

In the following description, an “interface device” may include one or more interface devices. The one or more interface devices may be at least one of the following.
One or more input/output (I/O) interface devices. The input/output (I/O) interface device is an interface device for at least one of an I/O device and a remote display computer. The I/O interface device for a display computer may be a communication interface device. At least one I/O device may be any of user interface devices, for example, an input interface device such as a keyboard and a pointing device, and an output interface device such as a display device.
One or more communication interface devices. The one or more communication interface devices may be one or more communication interface devices of the same type (for example, one or more network interface card (NIC)) or two or more communication interface devices of different types (for example, NIC and host bus adapter (HBA)). Note that the network accessed by the communication interface device during communication may be, but is not limited to, the Internet, a local area network (LAN), a wide area network (WAN), or a mobile phone network.

In the following description, a “memory” includes one or more memory devices serving as an example of one or more storage devices, and may typically be a main storage device. At least one memory device in the memory may be a volatile memory device or a non-volatile memory device.

In the following description, a “storage” may include one or more persistent storage devices, which is an example of the one or more storage devices. The persistent storage device may typically be a non-volatile storage device (for example, an auxiliary storage device), and specifically, for example, a hard disk drive (HDD), a solid state drive (SSD), a non-volatile memory express (NVMe) drive, or a storage class memory (SCM).

In the following description, the “storage device” may be at least the memory of the memory and the storage.

In the following description, a “processor”, which is a computing device, may include one or more processor devices. At least one processor device may typically include a micro-processor device such as a central processing unit (CPU), and may include another type of processor device such as a graphics processing unit (GPU). The at least one processor device may be a single core or a multi-core. The at least one processor device may be a processor core. The at least one processor device may be a broadly defined processor device such as a hardware circuit (for example, a field-programmable gate array (FPGA), a complex programmable logic device (CPLD), or an application specific integrated circuit (ASIC)) that performs a part or all the processing.

In the following description, information that can be output in response to an input may be described by an expression such as “xxx database” or “xxx table”, whereas the information may be data of any structure (for example, may be structured data or unstructured data), and may be a learning model such as a neural network, a genetic algorithm, or a random forest that generates an output in response to an input. Therefore, “xxx database” and “xxx table” can be rephrased as “xxx information”. In the following description, a configuration of each of databases or tables is an example. One database or table may be divided into two or more databases or tables, or all or a part of two or more databases or tables may be one database or table.

In the following description, processing may be described using a “program” as a subject, but since a program is executed by a processor to perform predetermined processing using a storage device and/or an interface device as appropriate, the subject of the processing may be the processor (or a device such as a controller including the processor). The program may be installed on a device such as a computer from a program source. The program source may be, for example, a program distribution server or a computer-readable (for example, non-transitory) recording medium. In addition, in the following description, two or more programs may be implemented as one program, or one program may be implemented as two or more programs.

In the following description, a “confidential computation system” may be a system (for example, a cloud computing system) implemented on a group of physical computing resources (for example, a cloud infrastructure), or may be a system (for example, an on-premise system) implemented by one or more physical computers. The confidential computation system “displaying” display information may mean displaying the display information on a display device possessed by a computer, or may mean a computer transmitting the display information to a display computer (in the latter case, the display information is displayed by the display computer).

### Definition of Terms

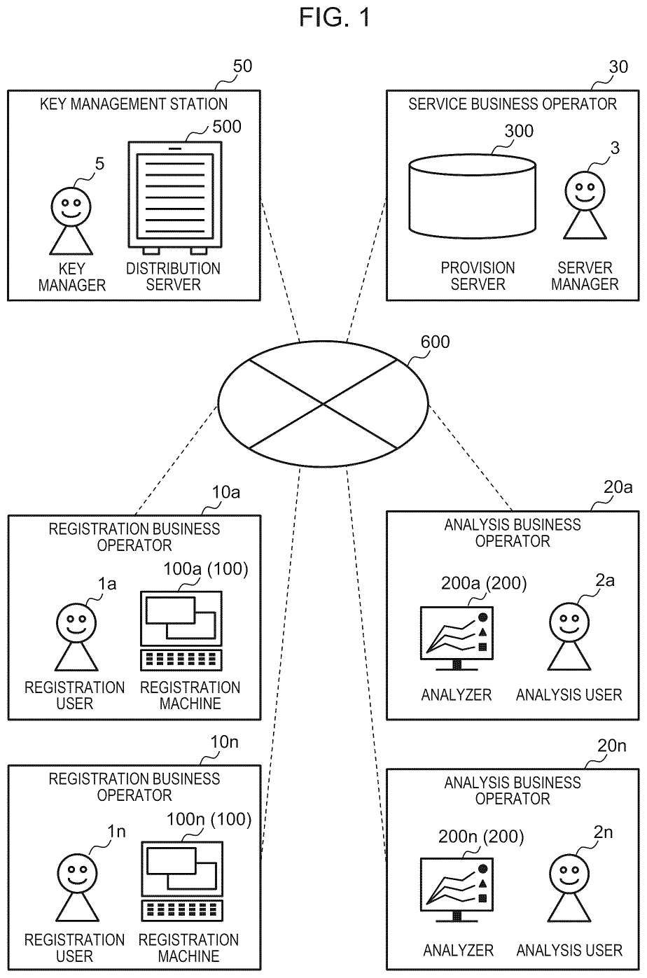

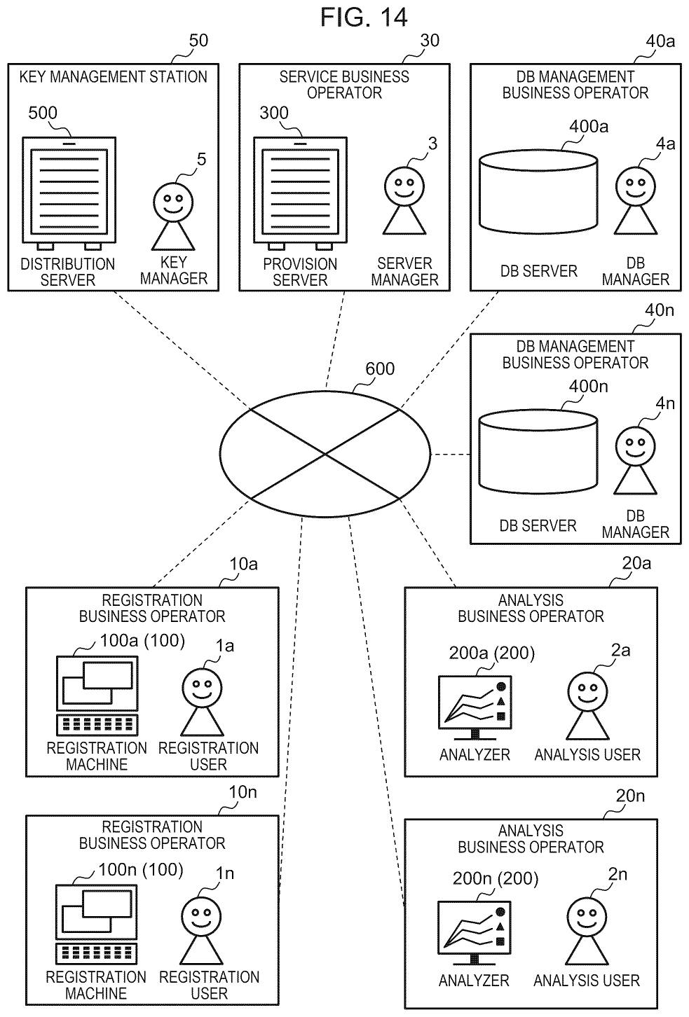

First, definitions of terms used in the following description related to the embodiments and modifications of the invention will be described with reference to FIGS. 1 and 14.

FIG. 1 is a diagram illustrating an example of an overall configuration of a system including a confidential computation system 1000 according to each of Embodiments 1 to 2. FIG. 14 is a diagram illustrating an example of a configuration of an entire system including the confidential computation system 1000 according to Embodiment 3.

### (1) Plaintext

This indicates information before encryption. Plaintext data PD, a plaintext word PW, and a plaintext query PQ handled by the confidential computation system 1000 according to the invention are all plaintexts.

### (2) Encrypted Text

This indicates encrypted information. Encrypted data ED, an encrypted word EW, and an encrypted query EQ handled by the confidential computation system 1000 according to the invention are all encrypted texts.

### (3) Key

This is information used for operations such as encryption and decryption. A word key WK, a query key QK, a data key DK, and a key generation key KK handled by the confidential computation system 1000 according to the invention are all keys.

### (4) Registration Machine

This indicates any one or all of a registration machine 100a, a registration machine 100b, a registration machine 100c, . . . , and a registration machine 100n (hereinafter, collectively referred to as a “registration machine 100” when these registration machines are collectively described or not particularly distinguished). A registration user 1 operates the registration machine 100 to appropriately manage and use the key and the plaintext.

### (5) Analyzer

This indicates any one or all of an analyzer 200a, an analyzer 200b, an analyzer 200c, . . . , and an analyzer 200n (hereinafter, collectively referred to as an “analyzer 200” when these analyzers are collectively described or not particularly distinguished). An analysis user 2 operates the analyzer 200 to appropriately manage and use the key and the plaintext.

### (6) Provision Server

In the invention, the encrypted text is managed in consideration of a risk of causing information leakage from a server manager 3 or an unauthorized intruder. After a search, when a hit number of the search exceeds a certain number, only the encrypted text related to the search result is allowed to be converted into the plaintext to perform an operation.

### (7) Distribution Server

A key is distributed in cooperation with the registration machine 100 and the analyzer 200. The key for distribution is generated or deposited in advance and safely managed. Note that any one or all of the registration machine 100, the analyzer 200, and the provision server 300 may serve as a role of a distribution server 500. For example, the registration machine 100 may generate, distribute, and manage a key. For example, a trusted region such as a trusted execution environment (TEE) in which security is ensured may be set in the provision server 300, and may generate, distribute, and manage a key, as the distribution server 500. For example, the registration machine 100 and the analyzer 200 may generate, distribute, and manage a key respectively.

### (8) Symmetric Key Encryption

An encryption function and a decryption function are provided for processing generation of a key and encryption and decryption of data. The following AES encryption, 3DES encryption, and the like are known as typical symmetric key encryption.

Reference document of AES encryption: NIST FIPS 197-upd1, Advanced Encryption Standard (AES), https://nvlpubs.nist. gov/nistpubs/FIPS/NIST. FIPS. 197.pdf

Reference document of 3DES encryption: NIST Special Publication (SP) 800-67 Revision 2, Recommendation for the Triple Data Encryption Algorithm (TDEA) Block Cipher.
https://nvlpubs.nist.gov/nistpubs/SpecialPublication S/NIST.SP.800-67r2.pdf

The encryption function receives a plaintext and a key and outputs an encrypted text. The decryption function receives an encrypted text and a key and outputs a plaintext.

### (9) Searchable Encryption

This has a word encryption function, a query encryption function, and a comparison function. In addition to the following method proposed by Reza Curtmola, many methods are known. Reference document: Reza Curtmola, Juan A. Garay, Seny Kamara, Rafail Ostrovsky: Searchable Symmetric encryption: improved definitions and efficient constructions.
https://web.cs.ucla.edu/˜rafail/PUBLIC/74.pdf

The word encryption function receives the plaintext word PW and the word key WK, and outputs the encrypted word EW.

The query encryption function receives the plaintext query PQ and the query key QK, and outputs the encrypted query EQ.

The comparison function receives the encrypted word EW and the encrypted query EQ, and outputs 1 if PW=PQ, and outputs 0 if PW≠PQ. If 1 is output, it is determined that the encrypted word EW and the encrypted query EQ match, and if 0, it is determined that the encrypted word EW and the encrypted query EQ do not match.

Note that, theoretically, a possibility of outputting 1 is not 0 even in PQ≠PQ, but this possibility is sufficiently small, and thus the discussion will be omitted in the present specification.

In the generation of the encrypted word EW, the same comparison is possible while receiving a plaintext different from the plaintext word PW. If the encrypted word EW and the encrypted query EQ match by the comparison, a plaintext embedded in the encrypted word EW can be decrypted. At this time, as a comparison result, 1 indicating the match and the corresponding plaintext are output, or 0 indicating a non-match and a random number are output.

The word key WK and the query key QK may be the same key.

### (10) Secret Sharing

This has a polynomial generation function, a share generation function, and a reconstruction function. In addition to the following method proposed by Adi Shamir, many methods are known. Reference document: Adi Shamir, “How to Share a Secret,” Commun. ACM, vol. 22, no. 11, pp. 612 to 613, 1979.

The polynomial generation function receives confidential information C and a threshold t, and outputs a t-dimensional polynomial P in which the confidential information is concealed.

The share generation function generates any number of shares S from the polynomial P.

The reconstruction function receives t or more shares S having different values and the polynomial P, and reconstructs the confidential information C.

Note that the polynomial generation function is not necessarily possessed.

### Embodiment 1

### Configuration Example of System

Next, a configuration example of the confidential computation system 1000 according to Embodiment 1 (and Embodiment 2 described later) will be described with reference to FIGS. 1 to 3.

### Configuration Example of Entire System

The confidential computation system 1000 according to Embodiment 1 is a computer system capable of disclosing a plaintext and executing any computation only when a hit number of the search is a certain number or more on a server operated by a third party organization such as a cloud while entrusting management of the encrypted text to the third party organization, and is implemented by a plurality of computers or servers each including configurations described later. When the hit number is less than the certain number, the information remains encrypted and is not disclosed, and the encrypted text maintains confidentiality.

A technology provided by the confidential computation system 1000 is effective for providing a recommended service using a specific date such as a birthday. A birthday of a user is safely managed, it is determined that a risk of personal identification is low for users with the same birthday who have been registered up to a certain number or more, and it is possible to provide a service of delivering a commemorative product, a prize, or the like based on the birthday, a service of prompting purchase of a product as a present, or the like. If the number of users registered with the same birthday is insufficient, the encryption is maintained to protect privacy of the users until the number of users registered with the same birthday reaches the certain number.

In addition, the technology provided by the confidential computation system 1000 is effective for providing a recommended service using a movement history, for example. Position information of a user is safely managed, and the recommended service using a movement history can be provided to a user who has registered a certain number or more pieces of position information. In addition, although the user having an insufficient number of registrations of the position information cannot use the recommended service, privacy of the user is protected because the position information is not disclosed instead.

In addition, the technology provided by the confidential computation system 1000 is effective for providing a recommended service using a medical history, for example. A date and time and medical examination results of a patient are safely managed, and the recommended service using a medical history can be provided to a patient having a certain number or more of medical examination results. Although a patient whose number of examination days does not satisfy a threshold cannot receive the recommended service, privacy of the patient is also protected.

As illustrated in FIG. 1, the confidential computation system 1000 at least includes a registration machine 100 operated by the registration user 1 in a registration business operator 10, the provision server 300 operated by the server manager 3 in a service business operator 30, and the analyzer 200 operated by an analysis user 2 in an analysis business operator 20. As illustrated in FIG. 1, the confidential computation system 1000 preferably includes the distribution server 500 operated by a key manager 5 of a key management station 50. In the following description, it is assumed that the confidential computation system 1000 includes one or more registration machines 100, one or more provision servers 300, one or more analyzers 200, and one or more distribution servers 500. In this case, as illustrated in FIG. 1, the registration machine 100, the provision server 300, the analyzer 200, and the distribution server 500 are connected to each other via an appropriate communication network (hereinafter, also simply referred to as a “network”) 600 such as the Internet or a dedicated line so as to be capable of performing data communication. The registration machine 100, the provision server 300, the analyzer 200, and the distribution server 500 are connected to the network 600 by a wire via well-known communication devices (not illustrated), but may be connected wirelessly.

Various devices such as another computer and server (hereinafter, also referred to as “another device”) may be connected to the registration machine 100, the provision server 300, the analyzer 200, and/or the distribution server 500 via the network 600 so as to be capable of performing data communication. In this case, the other devices and the network 600 may be connected by a wire via a well-known communication device (not illustrated) or may be connected wirelessly.

In the following description, registration business operators 10a, 10b, 10c, . . . , 10n are collectively referred to as a “registration business operator 10” when these registration business operators are collectively described or are not particularly distinguished. Similarly, registration users 1a, 1b, 1c, . . . , and In are collectively referred to as a “registration user 1” when these registration users are collectively described or are not particularly distinguished. Similarly, analysis business operators 20a, 20b, 20c, . . . , 20n are collectively referred to as an “analysis business operator 20” when these analysis business operators are collectively described or are not particularly distinguished. Similarly, analysis users 2a, 2b, 2c, . . . , 2n are collectively referred to as “analysis user 2” when these analysis users are collectively described or are not particularly distinguished.

### Configuration Example of Hardware

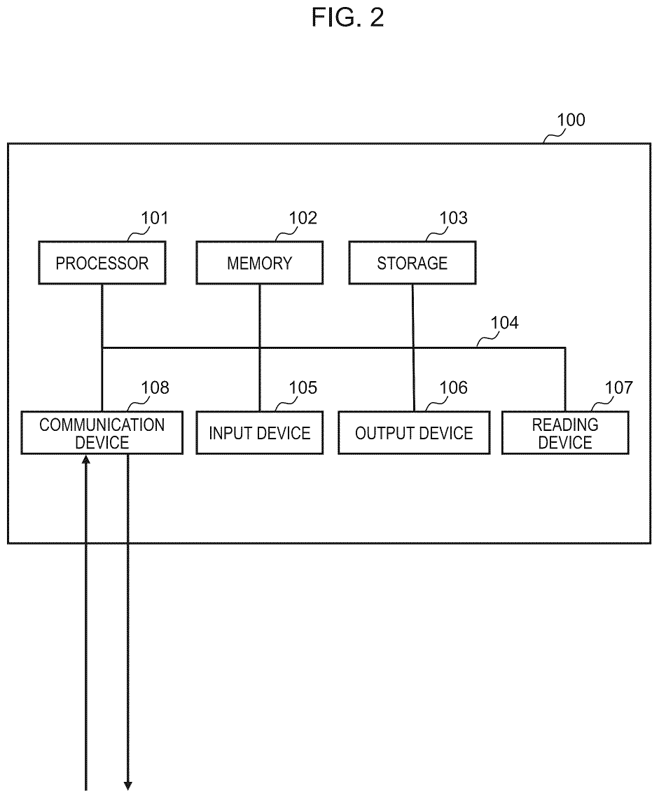

Next, an example of hardware structures of various devices (100, 200, 300, and 500) constituting the confidential computation system 1000 according to Embodiment 1 will be described with reference to FIG. 2.

FIG. 2 is a diagram illustrating an example of hardware structures of the registration machine 100, the provision server 300, the analyzer 200, and the distribution server 500 constituting the confidential computation system 1000 according to Embodiment 1 (and Embodiments 2 to 3 described later).

As illustrated in FIG. 2, any of the registration machine 100, the provision server 300, the analyzer 200, and the distribution server 500 constituting the confidential computation system 1000 is implemented by a computer at least including a storage device including a memory 102 and a storage 103, an interface device including at least a communication device 108, and a processor 101 connected to these devices. In the confidential computation system 1000, the interface device may include an input device 105, an output device 106, and/or a reading device 107.

In the following description, it is assumed that each of the registration machine 100, the provision server 300, the analyzer 200, and the distribution server 500 constituting the confidential computation system 1000 is implemented by one general-purpose computer including one or more processors 101, one or more memories 102, one or more storages 103, one or more communication devices 108, one or more input devices 105, one or more output devices 106, one or more reading devices 107, and a bus 104 that connects these devices to each other.

The storage 103 is an auxiliary storage device including a non-volatile storage element such as a flash memory. Specific examples of the storage 103 include a solid state drive (SSD) and a hard disk drive (HDD). The storage 103 stores at least various computer programs for implementing functions necessary for the confidential computation system 1000.

The various programs described above are provided to the devices (100, 200, 300, 500) via various removable media (not illustrated) such as a CD-ROM or a flash memory or via the network 600, and are stored in the non-volatile storage 103 which is a non-transitory storage medium. Therefore, as described above, it is preferable that each of the registration machine 100, the provision server 300, the analyzer 200, and the distribution server 500 constituting the confidential computation system 1000 includes the reading device 107 for reading data from the removable medium.

The various programs described above may be installed from a program source. The program source may be, for example, a program distribution computer or a computer-readable recording medium. The various programs described above may be implemented by a device driver, an operating system, various application programs located at a higher layer of the device driver and the operating system, or a library that provides a common function to these programs. Two or more programs may be implemented by one program, or one program may be implemented by two or more programs.

The storage 103 stores data representing various types of information.

The memory 102 is a main storage device mainly including a volatile storage element such as a random access memory (RAM). The memory 102 includes a ROM including a non-volatile storage element. The ROM stores an immutable program (for example, BIOS). The memory 102 temporarily holds data indicating various types of information read from the storage 103 and various types of data acquired via the communication device 108, the input device 105, and/or the reading device 107.

When various programs are executed by the processor 101, these programs stored in the storage 103 are read and temporarily held in the memory 102.

The processor 101 is a processor device such as a central processing unit (CPU) and various co-processors. The processor 101 calls various computer programs into the memory 102 and executes the computer programs to execute overall control of the devices (100, 200, 300, 500) themselves and controls a control unit (not illustrated) that executes various types of processing such as computing processing and determination processing.

In addition to the reading device 107 described above, the interface device includes a communication device 108 that controls a communication unit (not illustrated) described later, the input device 105 that controls an input unit (100A, 200A, 300B, 500B) described later, and an output device 106 that controls an output unit (100D, 200C, 300H, 500D) described later.

The communication device 108 is a network interface device that controls communication with the other devices via the network 600.

The input device 105 is any type of an input interface device that receives an input from a user, such as a keyboard, a mouse, and a touch screen.

The output device 106 is any type of an output interface device that outputs a result of executing a program in a format recognizable by a user, such as various display devices (not illustrated) such as a liquid crystal display or a touch screen, a speaker, or a printer.

The processor 101, the memory 102, the storage 103, the input device 105, the output device 106, the reading device 107, and the communication device 108 are connected by the bus 104 as described above, and data and programs are transmitted to each other via the bus 104.

The registration machine 100, the provision server 300, the analyzer 200, and the distribution server 500 constituting the confidential computation system 1000 may be independent devices or embedded devices.

### Example of Functional Block

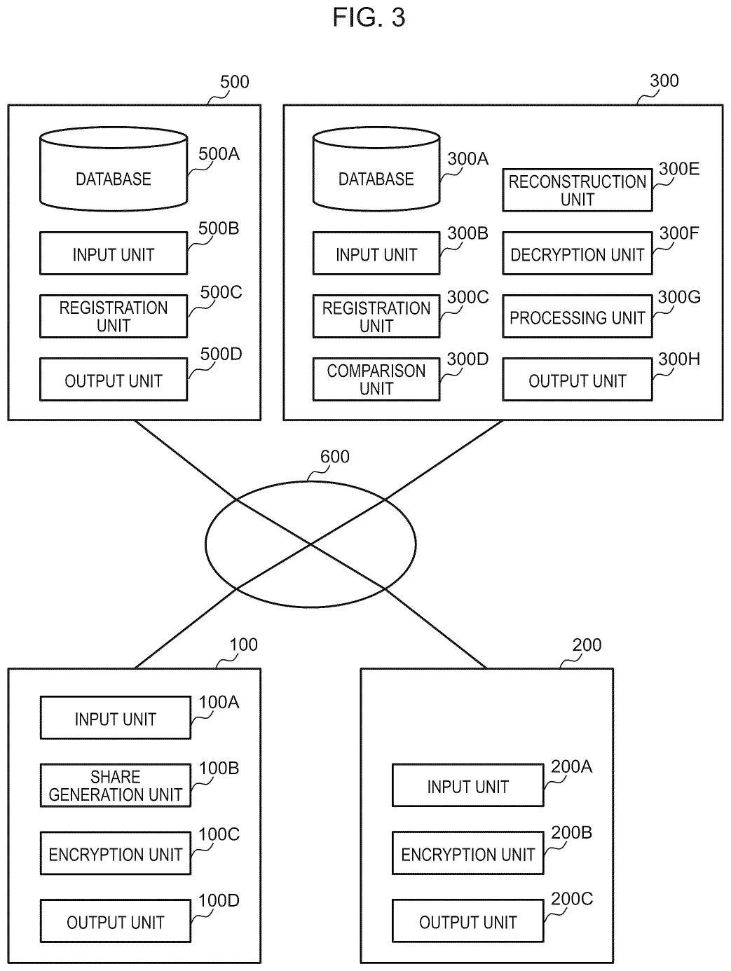

Next, an example of blocks of various functions included in various devices (100, 200, 300, 500) constituting the confidential computation system 1000 according to Embodiment 1 will be described with reference to FIG. 3. Each of the blocks to be described below does not represent a hardware unit configuration but represents a functional unit block.

FIG. 3 is a diagram illustrating an example of functional blocks of various devices (100, 200, 300, 500) constituting the confidential computation system 1000 according to Embodiment 1 (and Embodiment 2 described later).

The registration machine 100 includes functional blocks including a storage unit (not illustrated), the input unit 100A, a control unit (not illustrated), a communication unit (not illustrated), and the output unit 100D. The input unit 100A mainly executes processing of receiving various input operations from the registration user 1 and processing of reading the plaintext data PD and the plaintext word PW. The control unit includes functional blocks including a share generation unit 100B and an encryption unit 100C. The share generation unit 100B executes various types of processing for generating a share S (details will be described later). The encryption unit 100C executes processing of converting the plaintext data PD into the encrypted data ED and converting the plaintext word PW into the encrypted word EW by using a designated key. The communication unit is in charge of communication processing with the other devices such as the provision server 300, the analyzer 200, and the distribution server 500, which is performed via the network 600. The output unit 100D mainly executes processing of transmitting the encrypted data ED and the encrypted word EW.

The analyzer 200 includes functional blocks including a storage unit (not illustrated), the input unit 200A, a control unit (not illustrated), a communication unit (not illustrated), and the output unit 200C. The input unit 200A mainly executes processing of receiving various input operations from the analysis user 2 and processing of reading the plaintext query PQ. The control unit includes an encryption unit 200B as a functional block. The encryption unit 200B executes processing of converting the plaintext query PQ into the encrypted query EQ by using a designated key. The communication unit is in charge of communication processing with the other devices such as the registration machine 100, the provision server 300, and the distribution server 500, which is performed via the network 600. The output unit 200C mainly executes processing of transmitting the encrypted query EQ.

The provision server 300 includes functional blocks including a storage unit (not illustrated), the input unit 300B, a control unit (not illustrated), a communication unit (not illustrated), and the output unit 300H. The storage unit stores at least a database 300A. The database 300A manages any number of tables. Each of the tables includes a search index for managing the encrypted word EW and a data management table for managing the encrypted data ED. The input unit 300B mainly executes processing of receiving various input operations from the server manager 3 and processing of reading the encrypted data ED, the encrypted word EW, and the encrypted query EQ. The control unit includes functional blocks including a registration unit 300C, a comparison unit 300D, a reconstruction unit 300E, a decryption unit 300F, and a processing unit 300G. The registration unit 300C executes processing of registering the encrypted word EW and the encrypted data ED in the database 300A. The comparison unit 300D executes processing of comparing the encrypted word EW with the encrypted query EQ. The reconstruction unit 300E executes processing of reconstructing confidential information from the share S. The decryption unit 300F executes processing of converting the encrypted data ED into the plaintext data PD. The processing unit 300G executes processing of creating data for output based on the plaintext data PD. The communication unit is in charge of communication processing with the other devices such as the registration machine 100, the analyzer 200, and the distribution server 500, which is performed via the network 600. The output unit 300H mainly executes processing of transmitting the data for output.

The distribution server 500 includes functional blocks including a storage unit (not illustrated), the input unit 500B, a control unit (not illustrated), a communication unit (not illustrated), and the output unit 500D. The storage unit stores at least a database 500A. The database 500A manages keys. The input unit 500B mainly executes processing of receiving various input operations from the key manager 5, processing of receiving a command such as a distribution request, and processing of reading a key. The control unit includes a registration unit 500C as a functional block. The registration unit 500C executes processing of generating a key or processing of registering the transmitted key in the database 500A. The communication unit is in charge of communication processing with the other devices such as the registration machine 100, the analyzer 200, and the provision server 300, which is performed via the network 600. The output unit 500D mainly executes processing of transmitting a key from the database 500A.

That is, each of the registration machine 100, the analyzer 200, the provision server 300, and the distribution server 500 constituting the confidential computation system 1000 at least includes functional blocks including a control unit (not illustrated) mainly implemented by the processor 101, a storage unit (not illustrated) implemented by a storage device (102, 103), a communication unit (not illustrated) implemented by the communication device 108, and a user interface unit (not illustrated) implemented by the input device 105 and the output device 106.

The control unit executes various types of data processing based on programs and data stored in the storage unit and based on data acquired from the communication unit. The control unit also functions as an interface to the storage unit and the communication unit.

The control unit is implemented by the processor 101 and can implement the functional blocks described above by executing corresponding programs. Instead of the processor 101, the control unit may be implemented by a logic circuit, for example, a field-programmable gate array (FPGA) or an application specific integrated circuit (ASIC). The control unit may be implemented by a combination of the processor 101 and a logic circuit.

The storage unit is implemented by, for example, a storage device including the memory 102 and the storage 103, and stores programs for supplying various processing commands to the control unit and data indicating various types of information used in processing executed by the control unit.

As described above, the storage units of the provision server 300 and the distribution server 500 at least store corresponding databases (300A, 500A).

The control units of the provision server 300 and the distribution server 500 can execute various types of processing by reading and writing data representing the various types of information managed by the databases (300A, 500A) from and to the storage units.

The communication unit executes communication processing with the other devices and the like via the network 600. The communication unit is implemented by, for example, a network interface card (NIC) or a host bus adapter (HBA).

The user interface unit includes functional blocks including an input unit (100A, 200A, 300B, 500B) and an output unit (100D, 200C, 300H, 500D).

The input unit (100A, 200A, 300B, 500B) is in charge of processing related to an input, such as receiving an input operation from a user, of processing related to the user interface. The input unit (100A, 200A, 300B, 500B) is implemented by the input device 105 such as a keyboard, a mouse, or a touch screen, and detects various operations performed by the user.

The output unit (100D, 200C, 300H, 500D) is in charge of processing related to an output, such as displaying various screens on a display device and outputting audio, of processing related to the user interface. The output unit (100D, 200C, 300H, 500D) is implemented by various display devices such as a liquid crystal display and a touch screen.

Note that, for example, in a case of performing remote login to the device (100, 200, 300, 500) from another external device, in a case of receiving input information from an external device or providing output information to an external device via a communication unit, or the like, it is not essential to mount the input unit (100A, 200A, 300B, 500B) and/or the output unit (100D, 200C, 300H, 500D). In this case, the device (100, 200, 300, 500) has a web server function, so that the device (100, 200, 300, 500) may receive access from the external device according to a predetermined protocol.

That is, each of components of the registration machine 100, the analyzer 200, the provision server 300, and the distribution server 500 constituting the confidential computation system 1000 is implemented by hardware including the processor 101, the storage device such as the memory 102 and the storage 103, the bus 104 connecting these devices, and the interface device (105, 106, 107, 108), and software that is stored in the storage device (102, 103) and supplies a processing command to a calculator (processor 101).

The functions of the registration machine 100, the analyzer 200, the provision server 300, and the distribution server 500 constituting the confidential computation system 1000 have been described above on the assumption that the functions of the devices (100, 200, 300, and 500) are integrally implemented by one computer. However, the functions may be implemented by a plurality of computers and/or servers that are connected to each other. The device (100, 200, 300, 500) may include a general-purpose computer, such as a laptop PC, and a web browser installed in the general-purpose computer device, or may include a web server and various types of portable devices.

Each of the registration machine 100, the analyzer 200, the provision server 300, and the distribution server 500 constituting the confidential computation system 1000 is a computer system implemented on one physically single computer or a plurality of logically or physically implemented computers, and may operate on a virtual computer constructed on a plurality of physical computer resources. For example, each of functional units described above may operate on a separate physical or logical computer, or a combination of a plurality of functional units may operate on one physical or logical computer.

The description of the functions described above is an example. A plurality of functions may be integrated into one function, and one function may be divided into a plurality of functions.

The registration machine 100, the analyzer 200, the provision server 300, and the distribution server 500 constituting the confidential computation system 1000 may have other functions in addition to the functions described above. For example, each of the devices (100, 200, 300, 500) may include a part of various functions of the other devices as described above.

In the confidential computation system 1000, the distribution server 500 generates the key generation key KK, the word key WK, and the query key QK according to predetermined security parameters, and registers these keys in the database 500A. Thereafter, the distribution server 500 distributes the key generation key KK and the word key WK to the registration machine 100, and distributes the query key QK to the analyzer 200, and the registration machine 100 and the analyzer 200 complement these keys.

Note that the registration machine 100 or a using device may perform key generation on behalf of the distribution server 500 and pass the key to the distribution server 500.

In addition, the distribution server 500 may not include the database 500A, and may be configured to generate and distribute a key corresponding to a key request each time the key request is received.

### Operation Example of System

Next, processing after the distribution server 500 completes the distribution of the keys to the registration machine 100 and the analyzer 200 will be described.

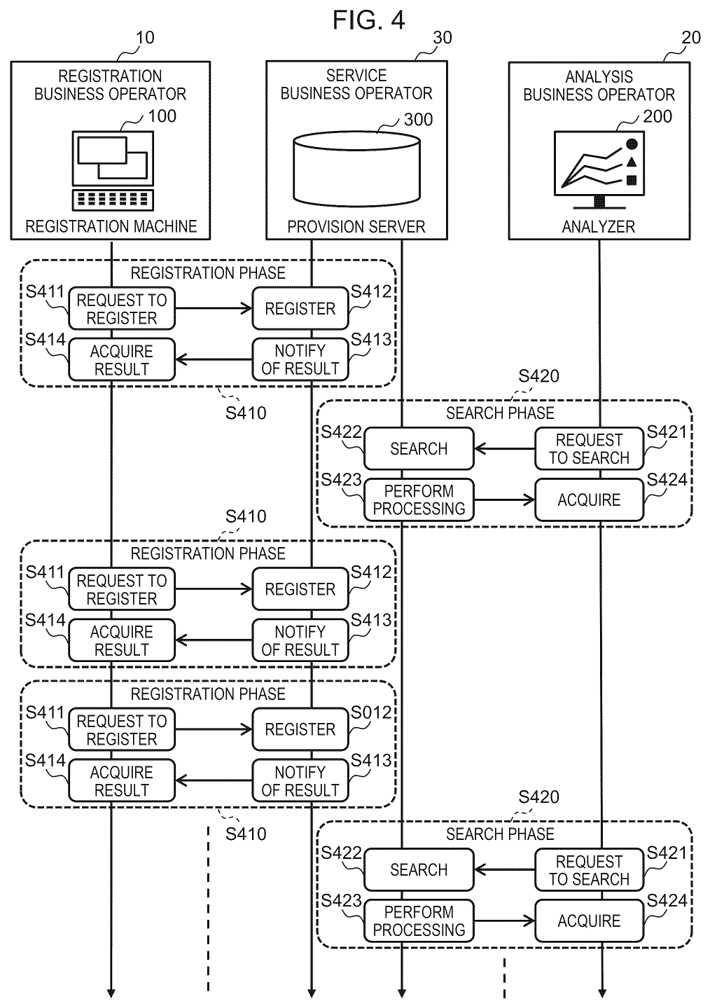

FIG. 4 is a sequence diagram illustrating an example of an overall flow of processing executed by the confidential computation system 1000 according to Embodiment 1 (and Embodiment 2 described later).

As illustrated in FIG. 4, the processing executed by the confidential computation system 1000 roughly includes a registration phase and a search phase.

In a registration phase of step S410, the registration machine 100 converts a plaintext into an encrypted text and requests the provision server 300 to register the encrypted text (step S411). The provision server 300 registers the encrypted text in the database 300A (step S412), and returns a registration result to the registration machine 100 (step S413). The registration machine 100 acquires the registration result (step S414).

In a search phase of step S420, the analyzer 200 converts the plaintext into the encrypted text, and requests the provision server 300 to perform a search (step S421). The provision server 300 searches the database 300A (step S422), and returns a result of processing a search result to the analyzer 200 (step S423). The analyzer 200 acquires the search result (step S424).

The registration phase of step S410 and the search phase of step S420 are repeated any number of times as necessary.

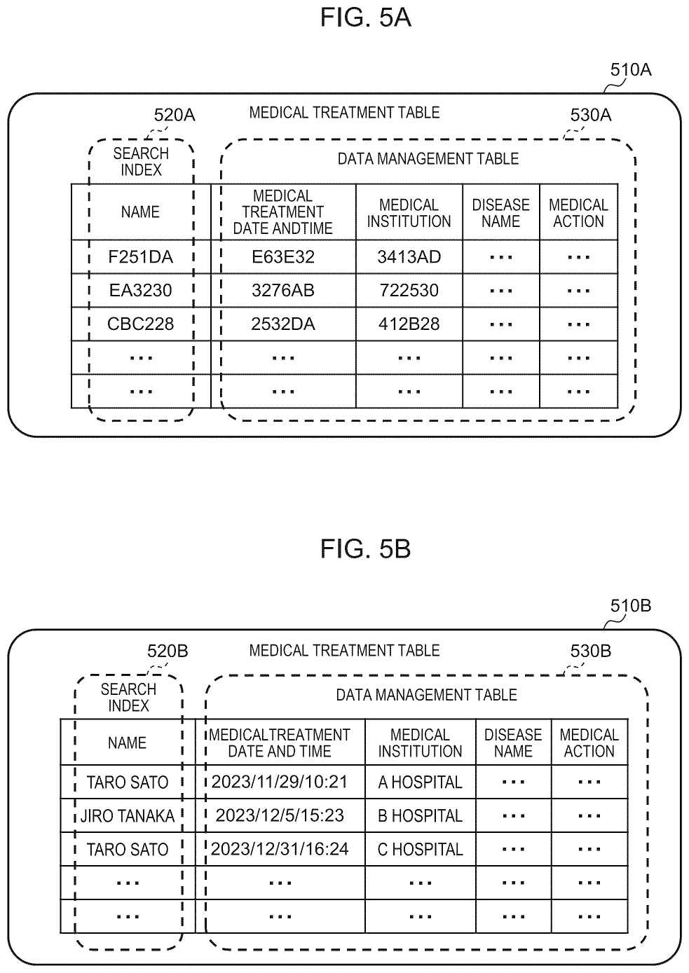

FIG. 5A illustrates, as an example of a table in the database 300A managed by the provision server 300, a medical treatment table including attributes such as a name, a medical treatment date and time, a medical institution, a disease name, and a medical action. The name in the medical treatment table is managed as a search index, and other attributes are managed in the data management table. The elements of the medical treatment table are encrypted except for the attribute, and cannot be distinguished from random numbers. For reference, FIG. 5B illustrates a medical treatment table before the encryption.

### Operation Example of Registration Machine 100

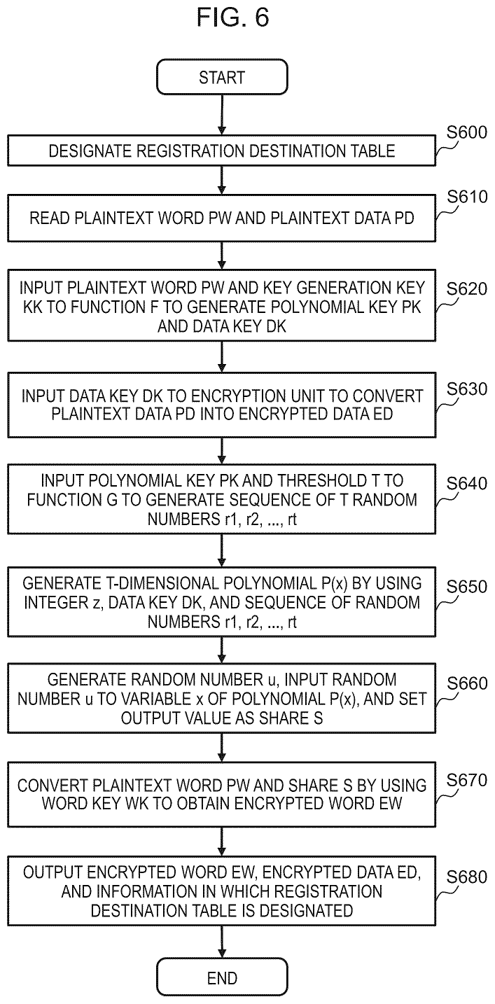

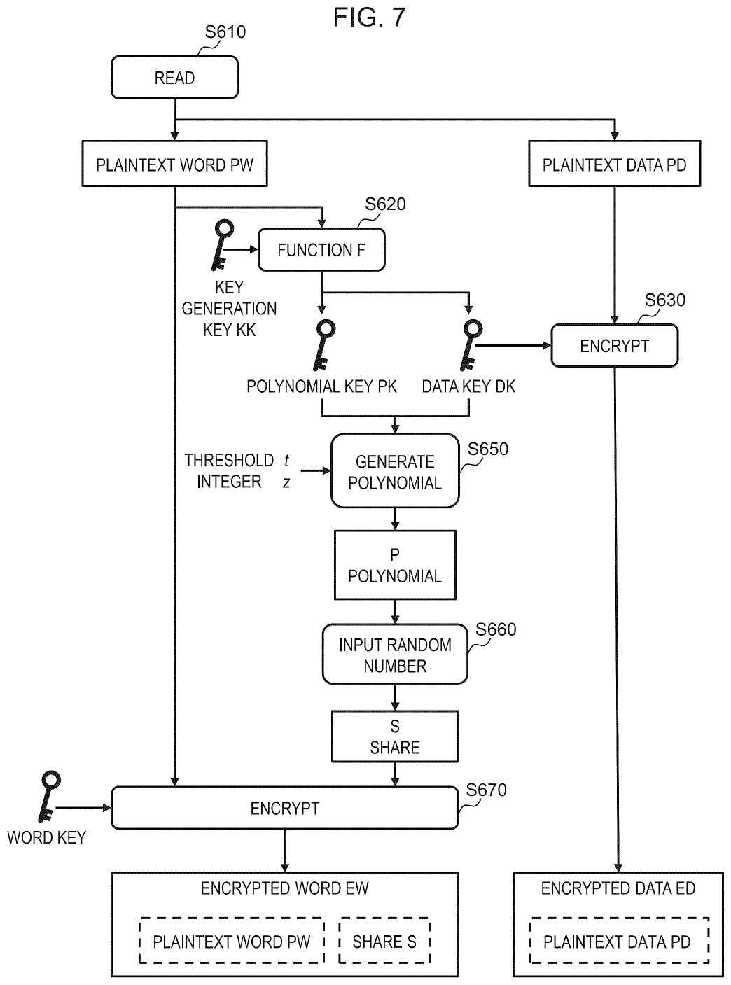

FIGS. 6 and 7 illustrate a procedure in which the registration machine 100 registers a set of the plaintext word PW and the plaintext data PD in the registration phase of the confidential computation system 1000.

In step S600, the control unit of the registration machine 100 executes processing of designating a registration destination table via the input unit 100A. Accordingly, the registration destination table is designated. When the processing of step S600 is completed, the control unit of the registration machine 100 proceeds to step S610.

In step S610, the control unit of the registration machine 100 executes processing of reading the plaintext data PD and the plaintext word PW from the table designated in step S600 via the input unit 100A. Accordingly, the plaintext data PD and the plaintext word PW are read from the table. When the processing of step S610 is completed, the control unit of the registration machine 100 proceeds to step S620.

In step S620, the control unit of the registration machine 100 executes processing of inputting the plaintext word PW and the key generation key KK to the following function F to generate a polynomial key PK and the data key DK by the share generation unit 100B.

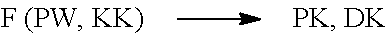

The function F generates the same output value from the same input value. Therefore, as long as the same key generation key KK is input, the polynomial key PK and the data key DK having the same value are obtained from the same plaintext word PW. An output of a function G is a pseudo random number that cannot be distinguished from a random number. Therefore, the plaintext word PW input to the function F cannot be estimated from PK and DK. The function F satisfying this property can be designed by using, for example, a cryptographic hash function. As a representative cryptographic hash function, the following SHA2 and the like are known.

Reference document of SHA2: NIST FIPS PUB 180-4, Secure Hash Standard (SHS) https://nvlpubs.nist. gov/nistpubs/FIPS/NIST.FIPS. 180-4.pdf

Accordingly, the polynomial key PK and the data key DK are generated. When the processing of step S620 is completed, the control unit of the registration machine 100 proceeds to step S630.

In step S630, the control unit of the registration machine 100 executes processing of inputting the data key DK to convert the plaintext data PD into the encrypted data ED by the encryption unit 100C. At this time, symmetric key encryption is used for the encryption. Accordingly, the plaintext data PD is converted into the encrypted data ED. When the processing of step S630 is completed, the control unit of the registration machine 100 proceeds to step S640.

In step S640, the control unit of the registration machine 100 executes processing of inputting the polynomial key PK and the threshold t to the following function G to generate a sequence of t random numbers r1, r2, . . . , rt by the share generation unit 100B.

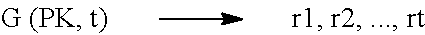

The sequence of random numbers r1, r2, . . . , rt depends on PK and the threshold t. Therefore, as long as the key generation key KK having the same value is input, the same sequence of random numbers r1, r2, . . . , rt can be generated from the same plaintext word PW. Accordingly, the sequence of t random numbers r1, r2, . . . , rt is generated. When the processing of step S640 is completed, the control unit of the registration machine 100 proceeds to step S650.

In step S650, the control unit of the registration machine 100 executes processing of generating, by the share generation unit 100B, the following t-dimensional polynomial P(x) in which the data key DK is a constant, a coefficient of an i-th order variable x is a random number ri, and a modulo (divisor) is an integer z.

$$P ( x ) = DK + r 1 x + r 2 x 2 + … + rt xt ( mod z )$$

Accordingly, the t-dimensional polynomial P(x) described above is generated. When the processing of step S650 is completed, the control unit of the registration machine 100 proceeds to step S660.

In step S660, the control unit of the registration machine 100 executes processing of generating a random number u, inputting the random number u to the variable x of the t-dimensional polynomial P(x), and setting an output value as the share S by the share generation unit 100B.

$$S = P ( u )$$

Accordingly, the share S is generated. The share S depends on the random number u. Therefore, even if the polynomial P is the same, if a random number space is sufficiently wide, a different value is output every time. Therefore, even if the plaintext word PW has the same value, different shares S are generated in step S660. When the processing of step S660 is completed, the control unit of the registration machine 100 proceeds to step S670.

In step S670, the control unit of the registration machine 100 executes processing of converting the plaintext word PW and the share S by using the word key WK to acquire the encrypted word EW by the encryption unit 100C. At this time, searchable encryption is used for the encryption. Therefore, the encrypted word EW can be compared with the encrypted query EQ to determine whether the plaintext word PW and the plaintext query PQ are the same in an encrypted state. Accordingly, the encrypted word EW is obtained. When the processing of step S670 is completed, the control unit of the registration machine 100 proceeds to step S680.

In step S680, the control unit of the registration machine 100 executes, via the output unit 100D, processing of transmitting the encrypted word EW, the encrypted data ED, and the information in which the registration destination table is designated as the data for output. Accordingly, the information is transmitted as the data for output. When the processing in step S680 is completed, the control unit of the registration machine 100 ends the processing illustrated in the flowchart of FIG. 6.

The above processing is the procedure of registering a set of the plaintext word PW and the plaintext data PD in the registration machine 100. Any number of pieces of the plaintext data PD and the plaintext words PW can be registered by the same processing. When a plurality of pieces of the plaintext data PD and a plurality of plaintext words PW are registered, changes may be made such that the processing of designating a table in step S600 is performed only once, or a plurality of encrypted words EW and a plurality of pieces of encrypted data ED are collectively output without being sequentially output in step S680.

The procedure of the processing described above is an example, and the processing order and the processing content may be changed as necessary.

In the encryption, other encryption methods such as public key encryption and searchable encryption may be used instead of the symmetric key encryption.

By the processing described above, the encrypted word EW and the encrypted data ED transmitted by the output unit 100D of the registration machine 100 are received by the input unit 300B of the provision server 300 via the network 600 (step S411). The registration unit 300C of the provision server 300 registers the encrypted word EW in the search index of the designated table in the database 300A, and registers the encrypted data ED in the data management table (step S412). The output unit 300H of the provision server 300 transmits the registration result via the network 600 (step S413), and the input unit 100A of the registration machine 100 receives the registration result (step S414).

### Operation Example of Analyzer 200

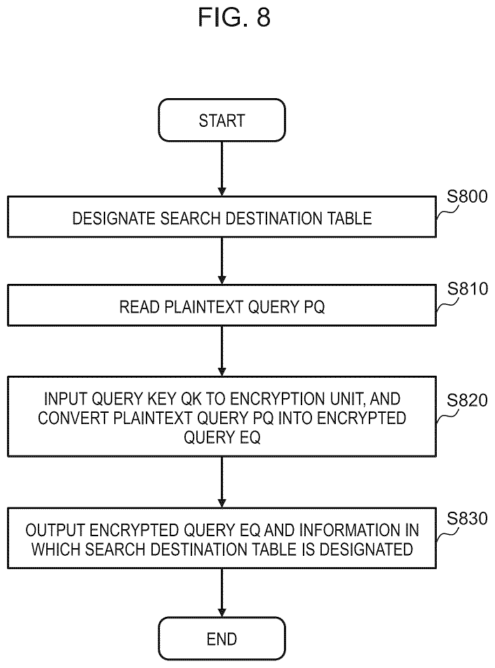

FIG. 8 illustrates a procedure in which the analyzer 200 requests a search for one plaintext query PQ in the search phase of the confidential computation system 1000.

In step S800, the control unit of the analyzer 200 executes processing of designating a search destination table via the input unit 200A. Accordingly, the search destination table is designated. When the processing of step S800 is completed, the control unit of the analyzer 200 proceeds to step S810.

In step S810, the control unit of the analyzer 200 executes processing of reading the plaintext query PQ via the input unit 200A. Accordingly, the plaintext query PQ is read. When the processing of step S810 is completed, the control unit of the analyzer 200 proceeds to step S820.

In step S820, the control unit of the analyzer 200 executes processing of inputting the query key QK and the plaintext query PQ to generate the encrypted query EQ by the encryption unit 200B, wherein searchable encryption is used for the encryption. Accordingly, the encrypted query EQ is generated. When the processing of step S820 is completed, the control unit of the analyzer 200 proceeds to step S830.

In step S830, the control unit of the analyzer 200 executes, via the output unit processing of transmitting, as the data for output, the encrypted query EQ and the information in which the search destination table is designated. Accordingly, the information is transmitted as the data for output. When the processing in step S830 is completed, the control unit of the analyzer 200 ends the processing illustrated in the flowchart of FIG. 8.

The procedure of the processing described above is an example, and the processing order and the processing content may be changed as necessary. The number of tables is not limited, and a plurality of tables may be designated.

Further, in the encryption, instead of the searchable encryption, other encryption methods capable of executing computing in an encrypted state, such as functional encryption or homomorphic encryption, may be used.

### Operation Example of Provision Server 300

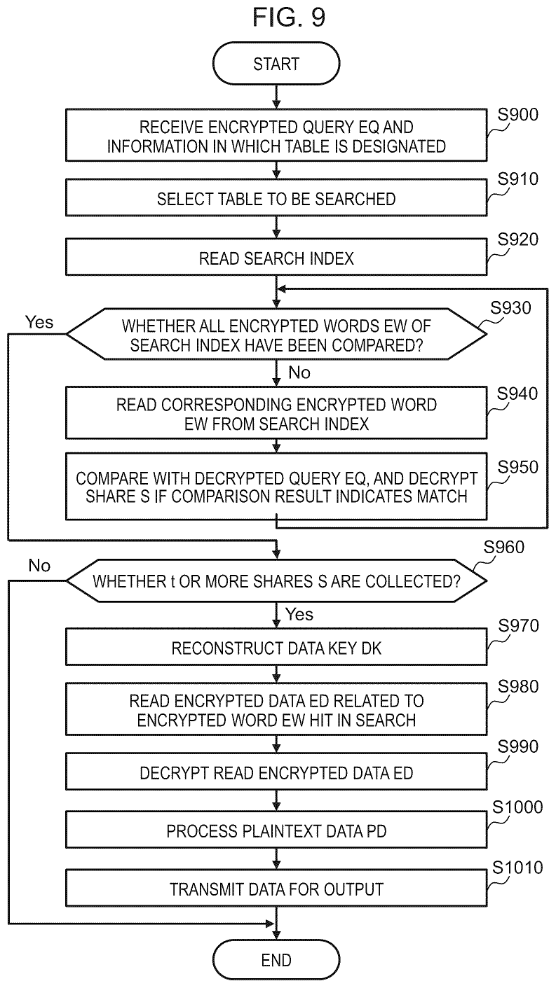

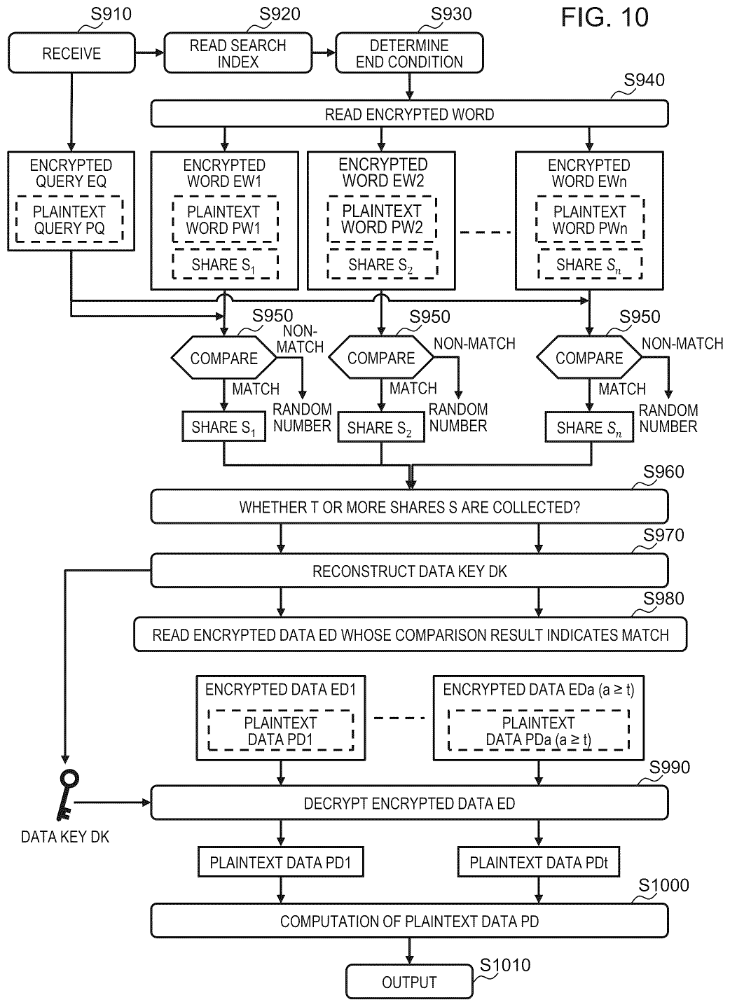

FIGS. 9 and 10 illustrate a procedure in which in the search phase of the confidential computation system 1000, the provision server 300 is requested by the analyzer 200 to search for one encrypted query EQ, and the data for output is transmitted.

In step S900, the control unit of the provision server 300 executes processing of receiving, via the input unit 300B, the encrypted query EQ and the information in which the table is designated. Accordingly, the information is acquired. When the processing of step S900 is completed, the control unit of the provision server 300 proceeds to step S910.

In step S910, the control unit of the provision server 300 executes processing of selecting a table to be searched according to the designated information. Accordingly, the table to be searched is selected. When the processing of step S910 is completed, the control unit of the provision server 300 proceeds to step S920.

In step S920, the control unit of the provision server 300 executes processing of reading a search index from the selected table via the input unit 300B. Accordingly, the search index is read. When the processing of step S920 is completed, the control unit of the provision server 300 proceeds to step S930.

In step S930, the control unit of the provision server 300 executes processing of determining whether there is an encrypted word EW that has not been compared yet in the search index read in step S920. If it is determined in step S930 that all the encrypted words EW in the search index have been compared and there is no encrypted word EW that has not been compared yet (step S930: YES), the processing proceeds to step S960. On the other hand, if it is determined in step S930 that there is an encrypted word EW that has not been compared yet in the search index (step S930: NO), the processing proceeds to step S940.

In step S940, the control unit of the provision server 300 executes processing of reading the encrypted word EW that has not been read yet from the search index via the input unit 300B. Accordingly, the encrypted word EW that has not yet been read is read from the search index. When the processing of step S940 is completed, the control unit of the provision server 300 proceeds to step S950.

In step S950, the control unit of the provision server 300 executes processing of comparing the encrypted query EQ with the encrypted word EW by using a comparison function of the searchable encryption by the comparison unit 300D. If the comparison result indicates a match, the embedded share S is decrypted. Accordingly, the encrypted query EQ is compared with the encrypted word EW, and if the comparison result indicates a match, the embedded share S is decrypted. When the processing of step S950 is completed, the control unit of the provision server 300 proceeds to step S960.

In step S960, the control unit of the provision server 300 executes processing of determining whether t or more shares S are collected by the reconstruction unit 300E. If it is determined in step S960 that t or more shares S are collected (step S960: YES), the processing proceeds to step S970. On the other hand, if it is determined in step S960 that t or more shares S are not collected (step S960: NO), the processing illustrated in the flowchart of FIG. 9 is ended as it is.

In step S970, the control unit of the provision server 300 executes processing of inputting t shares S and reconstructing the data key DK by the reconstruction unit 300E. Accordingly, the data key DK is reconstructed. When the processing of step S970 is completed, the control unit of the provision server 300 proceeds to step S980.

In step S980, the control unit of the provision server 300 executes, via the input unit 300B, processing of reading all the encrypted data ED related to the encrypted word EW whose comparison result is determined as a match. Accordingly, all the encrypted data ED is read. When the processing of step S980 is completed, the control unit of the provision server 300 proceeds to step S990.

In step S990, the control unit of the provision server 300 executes processing of using the data key DK to decrypt all the read encrypted data ED into the plaintext data PD by the decryption unit 300F. Accordingly, all the encrypted data ED is decrypted into the plaintext data PD. When the processing of step S990 is completed, the control unit of the provision server 300 proceeds to step S1000.

In step S1000, the control unit of the provision server 300 executes processing of performing any computation based on the plaintext data PD decrypted in step S990 to create the data for output by the processing unit 300G. As an example of the computation, the processing unit 300G may calculate a statistic of the plaintext data PD and create the data for output. For example, the processing unit 300G may analyze the plaintext data PD by machine learning and create the data for output. For example, the processing unit 300G may create an AI model obtained by learning the plaintext data PD and use the AI model as the data for output. For example, the processing unit 300G may perform conversion such as format processing or anonymization processing on the plaintext data PD to create the data for output. Accordingly, the data for output is created. When the processing of step S1000 is completed, the control unit of the provision server 300 proceeds to step S1010.

In step S1010, the control unit of the provision server 300 executes, via the output unit 300H, processing of transmitting the data for output created in step S1000. Accordingly, the data for output is transmitted. When the processing in step S1010 is completed, the control unit of the provision server 300 ends the processing illustrated in the flowchart of FIG. 9.

The processing described above is a procedure of comparing one encrypted query EQ in the provision server 300 with the encrypted word EW in the search index. Note that the same processing can be performed when comparing with some encrypted words EW in the search index. The encrypted query EQ and the encrypted word EW may be compared across a plurality of search indexes. The same processing can be performed when any number of encrypted queries EQ are compared with any number of encrypted words EW.

The procedure of the processing described above is an example, and the processing order and the processing content may be changed as necessary.

In the decryption, other encryption methods such as public key encryption and searchable encryption may be used instead of the symmetric key encryption.

By the processing described above, the encrypted query EQ transmitted by the output unit 200C of the analyzer 200 for the search request (step S421) is received by the input unit 300B of the provision server 300 via the network 600. The comparison unit 300D of the provision server 300 compares the encrypted word EW in the search index of the designated table in the database 300A with the encrypted query EQ, and the decryption unit 300F of the provision server 300 decrypts the share S based on the comparison result. The reconstruction unit 300E of the provision server 300 collects the decrypted share S and reconstructs the data key DK, and the decryption unit 300F of the provision server 300 decrypts the read encrypted data ED into the plaintext data PD by using the data key DK (step S422). The provision server 300 transmits data obtained by processing the plaintext data PD as the data for output via the network 600 (step S423), and the input unit 200A of the analyzer 200 receives the data for output (step S424).

As described above, in the confidential computation system 1000 according to Embodiment 1, while the management of the encrypted search index and the data management table is entrusted to the third party organization such as the cloud represented by the provision server 300, the related encrypted data ED can be decrypted into the plaintext data PD and any processing can be performed as long as the hit number of the search on the provision server 300 is a number determined by the threshold or more. When the hit number is less than the threshold, for example, when no hit is in the search, the encrypted data ED on the provision server 300 is not decrypted, and the confidentiality thereof is maintained.

In the confidential computation system 1000 according to Embodiment 1, the registration machine 100 may anonymize the plaintext data PD in advance, convert the obtained data into the encrypted data ED, and register the encrypted data ED in the provision server 300. For example, when the plaintext data PD is a birth year and date of an individual, as anonymization processing, the date may be deleted and only the birth year may be encrypted. When the hit number of the search on the provision server 300 is the number determined by the threshold or more and the related encrypted data ED is decrypted, only the birth year is disclosed to the provision server 300. Since only the birth year is disclosed, a specific identification risk of an individual is lower than that of disclosure of the birth year and date.

In the confidential computation system 1000 according to Embodiment 1, the registration machine 100 may anonymize the plaintext data PD in advance using a plurality of methods, convert the obtained data and the plaintext data PD into the encrypted data ED, and register the encrypted data ED in the provision server 300. As an example, the confidential computation system 1000 that registers the birthday of an individual in the provision server 300 is considered. When the birth year and date of the individual is registered as the plaintext data PD, anonymization processing for extracting the birth year and month by deleting the day and anonymization processing for extracting only the birth year by deleting the date are performed, and the obtained data and the plaintext data PD which is the birth year and date are converted into the encrypted data ED. The plaintext data PD in which the birth year and date is registered as it is has high confidentiality, and thus a high threshold such as “10” is set. Since the anonymized data in which the birth year and month are extracted has lower confidentiality than that of the plaintext data PD, a medium threshold such as “5” is set. The anonymized data in which the birth year is extracted has the lowest confidentiality, and a low threshold such as “3” is set. Since the thresholds are different from each other, appropriate data can be disclosed according to the hit number of the search on the provision server 300. For example, when the hit number of the search is 10 or more, the birth year and date is disclosed, and when the hit number of the search is only 3, only the birth year is disclosed.

In the confidential computation system 1000 according to Embodiment 1, the registration machine 100 may convert the plaintext data PD into intermediate encrypted data in advance by an encryption method capable of performing only specific computing, further convert the intermediate encrypted data, and register the obtained data as final encrypted data in the provision server 300. When the hit number of the search on the provision server 300 is the number determined by the threshold or more and the related final encrypted data is decrypted, the intermediate encrypted data is disclosed instead of the raw plaintext data PD, and thus specific computing can be processed on the provision server 300 without disclosing raw data on the provision server 300.

In the confidential computation system 1000 according to Embodiment 1, the registration machine 100 may register, in the provision server 300, the anonymized data obtained by performing anonymization processing on the plaintext data PD and the encrypted data ED obtained by encrypting the plaintext data PD. By setting a threshold for each of the anonymization processing method and the encryption method, appropriate anonymized data and encrypted data ED can be disclosed according to the hit number of the search on the provision server 300.

The confidential computation system 1000 according to Embodiment 1 has been described above.

### Embodiment 2

Next, the confidential computation system 1000 according to Embodiment 2 will be described focusing on a difference from the confidential computation system 1000 according to Embodiment 1.

In the confidential computation system 1000 according to Embodiment 2, while management of the encrypted text is entrusted to the third party organization such as the cloud, a plurality of tables are searched on a server operated by the third party organization, and only when the hit number of the search is a certain number or more in all or some of the tables, related plaintext is disclosed, and any computation including name identification processing and the like across the plurality of tables can be performed. When the hit number is less than the certain number, the information remains encrypted and is not disclosed, and the encrypted text maintains confidentiality.

The technology provided by Embodiment 2 is effective, for example, in providing a cooperative medical service using data related to a medical history and a level of required nursing care of a patient. An electronic medical record in which a medical history of a patient individually managed by a hospital is recorded and a nursing care receipt managed by a national health insurance organization are safely and centrally managed on a cloud, and a service for recommending an application for the level of required nursing care can be provided according to severity of a disease of the patient. Further, it is possible to provide a service for designing a rehabilitation item for the patient in consideration of both the disease and symptoms of the levels of nursing care. In addition, the encrypted data ED registered in only one of the electronic medical record and the nursing care receipt is not decrypted, and the confidentiality thereof is maintained.

A configuration of the confidential computation system 1000 according to Embodiment 2 is the same as that of the confidential computation system 1000 according to Embodiment 1. Hardware structure and functional block configurations of the registration machine 100, the provision server 300, the analyzer 200, and the distribution server 500 constituting the confidential computation system 1000 according to Embodiment 2 are also same as those of the devices (100, 300, 200, and 500) constituting the confidential computation system 1000 according to Embodiment 1.

A processing procedure of the confidential computation system 1000 according to Embodiment 2 includes the registration phase and the search phase, similarly to Embodiment 1. However, the database 300A managed by the provision server 300 includes one or more tables.

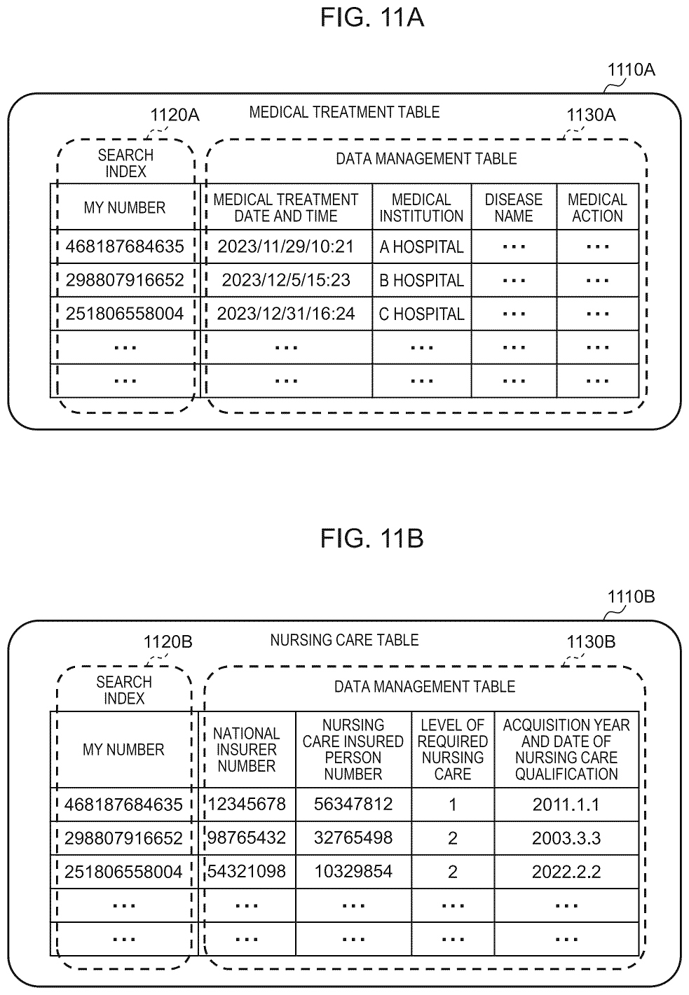

As examples of the tables in the database 300A managed by the provision server 300, FIG. 11A and FIG. 11B illustrate a medical treatment table including attributes such as a my number, a medical treatment date and time, a medical institution, a disease name, and a medical action, and a nursing care table including a my number, a national insurer number, a nursing care insured person number, a level of required nursing care, and an acquisition year and date of nursing care qualification, and the like. The my number is an attribute common in the medical treatment table and the nursing care table, and is managed as a search index of both tables. Other attributes are managed by a data management table of each of tables.

Similarly to Embodiment 1, the distribution server 500 according to Embodiment 2 generates the key generation key KK, the word key WK, and the query key QK according to predetermined security parameters, and registers these keys in the database 500A. Thereafter, the key generation key KK and the word key WK are distributed to the registration machine 100, the query key QK is distributed to the analyzer 200, and the registration machine 100 and the analyzer 200 complement these keys.

Note that the registration machine 100 or a using device may perform key generation on behalf of the distribution server 500 and pass the key to the distribution server 500. The distribution server 500 may be configured to generate and distribute a key every time a key request is received, and may not include the database 500A. Hereinafter, processing after the distribution server 500 completes the distribution of the keys to the registration machine 100 and the analyzer 200 will be described.

Processing of the registration phase according to Embodiment 2 is the same as that of Embodiment 1, and the description thereof will be omitted.

In the search phase of the confidential computation system 1000 according to Embodiment 2, a procedure in which the analyzer 200 requests a search for one plaintext query PQ is substantially the same as that of Embodiment 1.

In step S800, the control unit of the analyzer 200 executes, via the input unit 200A, processing of designating a plurality of search destination tables from a database (not illustrated). Accordingly, the plurality of search destination tables are designated from the database. When the processing of step S800 is completed, the control unit of the analyzer 200 proceeds to step S810.

In step S810, the control unit of the analyzer 200 executes processing of reading the plaintext query PQ via the input unit 200A. Accordingly, the plaintext query PQ is read. When the processing of step S810 is completed, the control unit of the analyzer 200 proceeds to step S820.

In step S820, the control unit of the analyzer 200 executes processing of inputting the query key QK and the plaintext query PQ to generate the encrypted query EQ by the encryption unit 200B, wherein searchable encryption is used for the encryption. Accordingly, the encrypted query EQ is generated. When the processing of step S820 is completed, the control unit of the analyzer 200 proceeds to step S830.

In step S830, the control unit of the analyzer 200 executes, via the output unit 200C, processing of transmitting, as the data for output, the encrypted query EQ and the information in which the plurality of search destination tables are designated. Accordingly, the information is transmitted as the data for output. When the processing in step S830 is completed, the control unit of the analyzer 200 ends the processing illustrated in the flowchart of FIG. 8.

The procedure of the processing described above is an example, and the processing order and the processing content may be changed as necessary. The number of tables is not limited, and one table may be designated.

Further, in the encryption, instead of the searchable encryption, other encryption methods capable of executing computing in an encrypted state, such as functional encryption or homomorphic encryption, may be used.

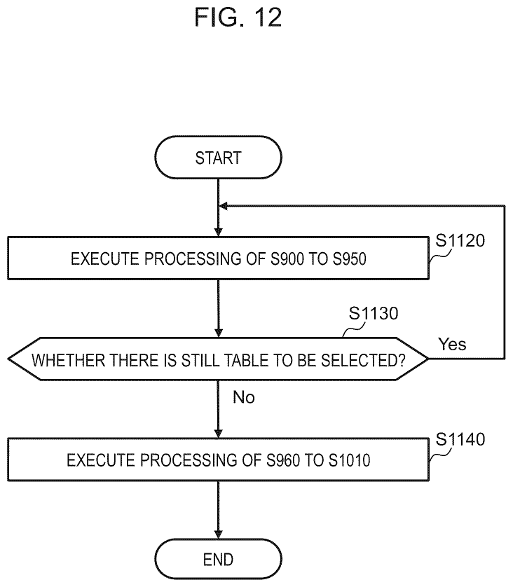

FIG. 12 illustrates a procedure in which the provision server 300 compares one encrypted query EQ with a search index in the plurality of designated tables and transmits output data in the search phase of the confidential computation system 1000.

In step S1120, the provision server 300 performs the processing from step S900 to step S950 in Embodiment 1. That is, in step S900, the input unit 300B of the provision server 300 receives the encrypted query EQ and the information in which the table is designated. In step S910, the input unit 300B of the provision server 300 selects a table to be searched according to the designated information. In step S920, the input unit 300B of the provision server 300 reads the search index from the selected table. In step S930, the input unit 300B of the provision server 300 confirms whether there is an encrypted word EW that has not been compared yet from the search index. If there is no such an encrypted word EW, the processing proceeds to step S1130. In step S940, the input unit 300B of the provision server 300 reads the encrypted word EW that has not been read yet from the search index. In step S950, the comparison unit 300D of the provision server 300 compares the encrypted query EQ with the encrypted word EW by using the comparison function of the searchable encryption. If the comparison result indicates a match, the embedded share S is decrypted.

In step S1130, the processing unit 300G of the provision server 300 confirms whether there is still a table that has not been searched from the information in which the table is designated. If there is such a table, the processing returns to step S1120.

In step S1140, the provision server 300 performs the processing from step S960 to step S1010 in Embodiment 1. That is, in step S960, the provision server 300 confirms whether t or more shares S have been collected, and if not collected, ends the processing. In step S970, if t or more shares S are collected, the data key DK is reconstructed. In step S980, all the encrypted data ED related to the encrypted word EW whose comparison result is determined as a match. In step S990, the data key DK is used to decrypt the read encrypted data ED into the plaintext data PD. In step S1000, any computation is performed based on the decrypted plaintext data PD, and data for output is created and transmitted. As the computation, for example, a statistic of the plaintext data PD may be calculated to create the data for output. The plaintext data PD may be analyzed by machine learning to create the data for output. Further, an AI model obtained by learning the plaintext data PD may be created, and the AI model may be used as the data for output. The plaintext data PD may be subjected to conversion such as format processing or anonymization processing to create the data for output. In step S1010, the data for output is transmitted.

A procedure in which the provision server 300 compares one encrypted query EQ with a search index in a plurality of designated tables and transmits output data will be described.

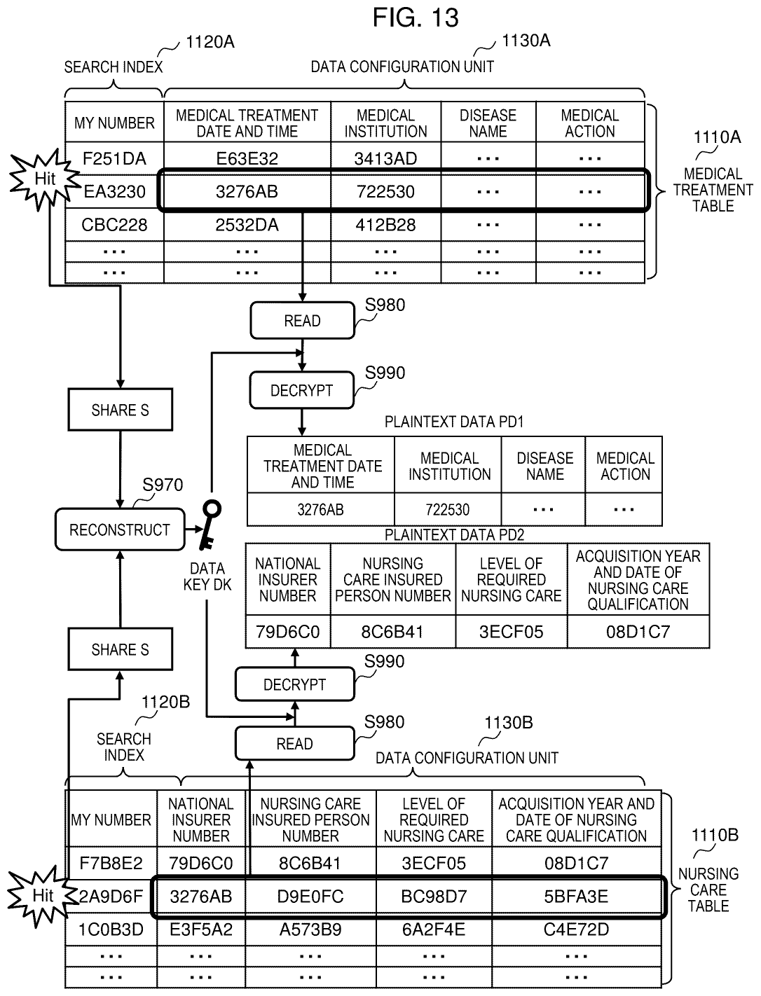

FIG. 13 illustrates a procedure of processing in which the provision server 300 compares one encrypted query EQ with a search index of a medical treatment table and a nursing care table, and decrypts the plaintext data PD in the search phase of the confidential computation system 1000. However, the threshold t is set to “2”.

From step S910 to step S950, the provision server 300 compares the search index of the medical treatment table and the nursing care table with the encrypted query EQ, and it is assumed that the hit number in each of the tables is one. Since the provision server 300 obtains two shares S, it is determined in step S960 that the number of shares S being the threshold or more is obtained. In step S970, the provision server 300 reconstructs the data key DK from the two shares S. In step S980, the provision server 300 reads the encrypted data ED in the same row as the encrypted word EW whose comparison result is determined as a match, and in step S990, the provision n server 300 reconstructs the encrypted data ED by using the data key DK and obtains plaintext data PD1 and plaintext data PD2. In step S1000, any computation is performed on the plaintext data PD1 and the plaintext data PD2. For example, both pieces of plaintext data (PD1 and PD2) may be combined, and may be learned by the AI together with the encrypted query EQ to output an AI model. In this combination, the encrypted query EQ and the encrypted word EW may be included in the combination result as keys in a common period, or other information may be used. In addition to the matching, for example, a statistic of the combined plaintext data PD may be obtained and output. In step S1010, the provision server 300 transmits the data for output.

As described above, in the confidential computation system 1000 according to Embodiment 2, while management of a plurality of encrypted tables is entrusted to a third party organization such as a cloud represented by the provision server 300, a search is performed on each of the tables on the provision server 300, and when the hit number of the search in each of the tables is a threshold or more, the related encrypted data ED is decrypted into the plaintext data PD, and computation across a plurality of tables can be performed. Further, when the hit number of the search in each of the tables is less than the number determined by the threshold, the encrypted data ED that is difficult to be processed across the plurality of tables is not decrypted, and the confidentiality thereof is maintained.

In the confidential computation system 1000 according to Embodiment 2, a setting may be made such that while management of a plurality of tables is entrusted, a search may be performed on each of the tables on the provision server 300, a threshold may be determined for each of the tables, and the share S can be reconstructed as long as the hit number of the search is the threshold determined in each of the tables or more. Accordingly, it is possible to set different thresholds for the tables when degrees of confidentiality of the tables are different.

The confidential computation system 1000 according to Embodiment 2 has been described above.

### Embodiment 3

Next, the confidential computation system 1000 according to Embodiment 3 will be described focusing on a difference from the confidential computation system 1000 according to Embodiment 1 and/or Embodiment 2.

In the confidential computation system 1000 according to Embodiment 3, it is possible to request a search for an encrypted text via a proxy server operated by another external organization while management of the encrypted text is entrusted to a third party organization such as a cloud. Only when the hit number of the search on the server operated by the third party organization is a certain number or more, the information can be disclosed in a plaintext on the proxy server to perform any computation. When the hit number is less than the certain number, the information remains encrypted and is not disclosed, and the confidentiality thereof is maintained.

In the technology provided by Embodiment 3, it is assumed that tables are not centrally managed, and the tables are managed by different organizations or different policies. For example, it is assumed that a hospital independently manages an electronic medical record in which a medical history of a patient is recorded, and a national health insurance organization independently manages a nursing care receipt. At this time, the proxy server can make an inquiry to organizations instead, and can provide a cooperative medical service using data related to the medical history and a level of required nursing care of the patient. The encrypted text corresponding to the search is aggregated in the proxy server, but when the search result is found to be a certain number or more after the aggregation, the information remains encrypted and is not disclosed even on the proxy server, and the confidentiality thereof is maintained.

FIG. 14 illustrates the example of the configuration of the confidential computation system 1000 according to Embodiment 3. The confidential computation system 1000 according to Embodiment 3 at least includes the registration machine 100 operated by the registration user 1 in the registration business operator 10, the provision server 300 operated by the server manager 3 as the service business operator 30, the analyzer 200 operated by the analysis user 2 in the analysis business operator 20, and a DB server 400 operated by a DB manager 4 in a DB management business operator 40, and preferably includes the distribution server 500 operated by the key manager 5 of the key management station 50.

In the following description of Embodiment 3, the registration business operators 10a, 10b, 10c, . . . , 10n are collectively referred to as the “registration business operators 10” when these registration business operators are collectively referred to or are not particularly distinguished. Similarly, registration users 1a, 1b, 1c, . . . , and In are collectively referred to as a “registration user 1” when these registration users are collectively described or are not particularly distinguished. Similarly, registration machines 100a, 100b, 100c, . . . , 100n are collectively referred to as the “registration machine 100” when these registration machines are collectively referred to or are not particularly distinguished. Similarly, the analysis business operators 20a, 20b, 20c, . . . , 20n are collectively referred to as an “analysis business operator 20” when these analysis business operators are collectively described or are not particularly distinguished. Similarly, the analysis users 2a, 2b, 2c, . . . , 2n are collectively referred to as “analysis user 2” when these analysis users are collectively described or are not particularly distinguished. Similarly, analyzers 200a, 200b, 200c, . . . , 200n are collectively referred to as the “analyzer 200” when these analyzers are collectively described or are not particularly distinguished. Similarly, DB management business operators 40a, 40b, 40c, . . . , 40n are collectively referred to as the “DB management business operator 40” when these DB management business operators are collectively described or are not particularly distinguished. Similarly, DB managers 4a, 4b, 4c, . . . , 4n are collectively referred to as the “DB manager 4” when these DB managers are collectively described or are not particularly distinguished. Similarly, DB servers 400a, 400b, 400c, . . . , 400n are collectively referred to as the “DB server 400” when these DB servers are collectively described or are not particularly distinguished.

The registration machine 100, the provision server 300, the analyzer 200, the distribution server 500, and the DB server 400 are connected to each other via the network 600 SO as to be capable of performing the data communication.

Hardware structures of the registration machine 100, the provision server 300, the analyzer 200, the distribution server 500, and the DB server 400 in Embodiment 3 are the same as those in Embodiment 1. The registration machine 100, the provision server 300, the analyzer 200, the distribution server 500, and the DB server 400 are, for example, computers, and are all implemented by substantially the same hardware as the devices (100, 300, 200, and 500) in Embodiments 1 to 2.

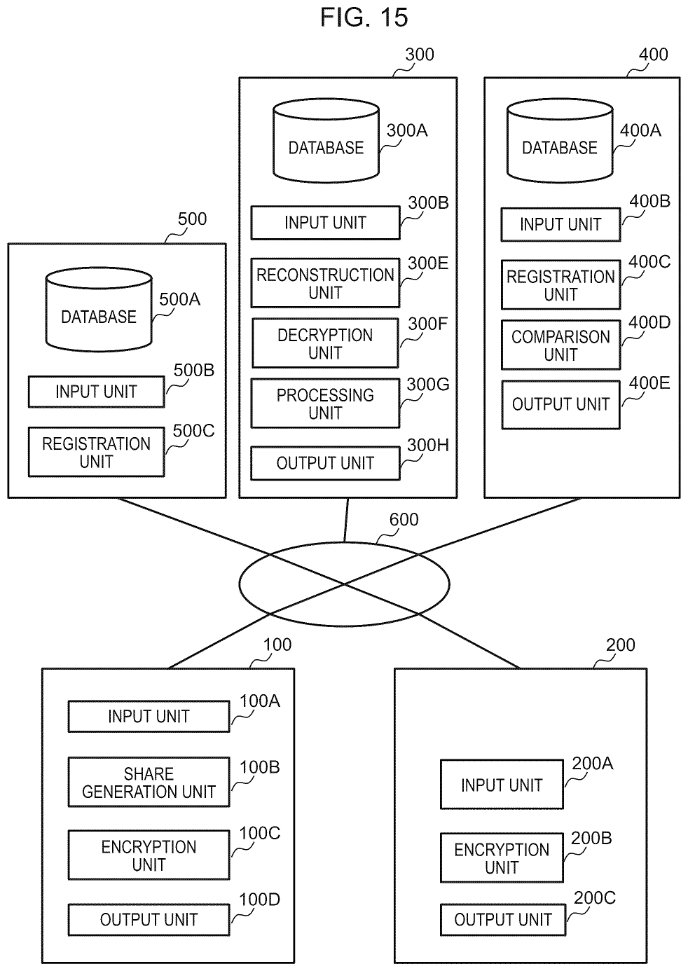

FIG. 15 illustrates an example of functional blocks of the confidential computation system 1000 according to Embodiment 3.

Configurations of the functional blocks of the registration machine 100, the analyzer 200, and the distribution server 500 in Embodiment 3 are the same as those in Embodiments 1 to 2.

The provision server 300 according to Embodiment 3 includes functional blocks including a storage unit (not illustrated), the input unit 300B, a control unit (not illustrated), a communication unit (not illustrated), and the output unit 300H. The storage unit stores at least the database 300A. The database 300A manages the encrypted text in the table. The input unit 300B mainly executes processing of receiving various input operations from the server manager 3 and processing of reading the encrypted data ED, the encrypted word EW, the encrypted query EQ, and data for temporary output. The control unit includes functional blocks including the reconstruction unit 300E, the decryption unit 300F, and the processing unit 300G. The reconstruction unit 300E executes processing of reconstructing confidential information from the share S of secret sharing. The decryption unit 300F executes processing of reconstructing the encrypted data ED to the plaintext data PD. The processing unit 300G executes processing of creating the data for final output based on the plaintext data PD. The communication unit is in charge of communication processing with the other devices such as the registration machine 100, the analyzer 200, the DB server 400, and the distribution server 500, which i performed via the network 600. The output unit 300H mainly executes processing of transmitting the data for final output, the encrypted data ED, the encrypted word EW, and the encrypted query EQ.

The DB server 400 according to Embodiment 3 includes functional blocks (not including a storage unit illustrated), an input unit 400B, a control unit (not illustrated), a communication unit (not illustrated), and an output unit 400E. The storage unit stores at least a database 400A. The database 400A manages an encrypted text in the table. Each of the tables includes a search index for managing the encrypted word EW and a data management table for managing the encrypted data ED. The input unit 400B mainly executes processing of receiving various input operations from the DB manager 4 and processing of reading the encrypted data ED, the encrypted word EW, and the encrypted query EQ. The control unit includes functional blocks including a registration unit 400C and a comparison unit 400D. The registration unit 400C executes processing of registering the encrypted word EW and the encrypted data ED in the database 400A. The comparison unit 400D executes processing of comparing the encrypted word EW with the encrypted query EQ. The communication unit is in charge of communication processing with the other devices such as the registration machine 100, the analyzer 200, the provision server 300, and the distribution server 500, which is performed via the network 600. The output unit 400E mainly executes processing of creating the data for temporary output based on the comparison result and transmitting the created data.

Similarly to Embodiment 1, the distribution server 500 according to Embodiment 3 generates the key generation key KK, the word key WK, and the query key QK according to predetermined security parameters, and registers these keys in the database 500A. Thereafter, the key generation key KK and the word key WK are distributed to the registration machine 100, the query key QK is distributed to the analyzer 200, and the registration machine 100 and the analyzer 200 complement these keys.

Note that the registration machine 100 or a using device may perform key generation on behalf of the distribution server 500 and pass the key to the distribution server 500. The distribution server 500 may be configured to generate and distribute a key every time a key request is received, and may not include the database 500A. Hereinafter, processing after the distribution server 500 completes the distribution of the keys to the registration machine 100 and the analyzer 200 will be described.

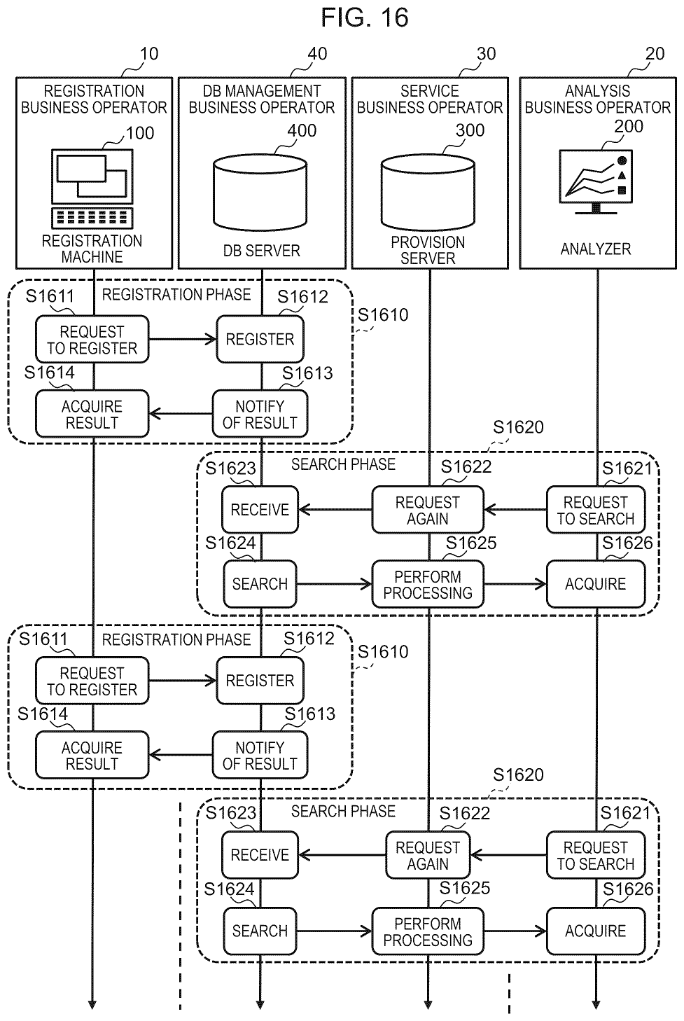

The processing procedure of the confidential computation system 1000 includes the registration phase and the search phase. This is illustrated in FIG. 16.

In a registration phase of step S1610, the registration machine 100 converts a plaintext into an encrypted text, and requests the DB server 400 to register the encrypted text (step S1611). The DB server 400 registers the encrypted text in the database 400A (step S1612) and sends back a registration result (step S1613), and the registration machine 100 acquires the registration result (step S1614).

In a search phase of step S1620, the analyzer 200 converts a plaintext into an encrypted text, and requests the provision server 300 to perform a search (step S1621). The provision server 300 requests the DB server 400 to perform the search again (step S1622). The DB server 400 searches the database 400A according to the re-request (step S1623), and transmits a search result to the provision server 300 (step S1624). The provision server 300 transmits a result obtained by processing the received search result to the analyzer 200 (step S1625), and the analyzer 200 acquires the result (step S1626).

The registration phase in step S1610 and the search phase in step S1620 are repeated any number of times as necessary.

In the registration phase of the confidential computation system 1000 according to Embodiment 3, the DB server 400 is in charge of the processing of the provision server 300 in the registration phase according to Embodiment 1. Contents of the processing performed by the registration machine 100 and the DB server 400 are the same as those in Embodiment 1, and the description thereof will be omitted.

In the search phase of the confidential computation system 1000 according to Embodiment 3, the procedure in which the analyzer 200 requests the search for one plaintext query PQ is the same as that of Embodiment 1, and the description thereof will be omitted.

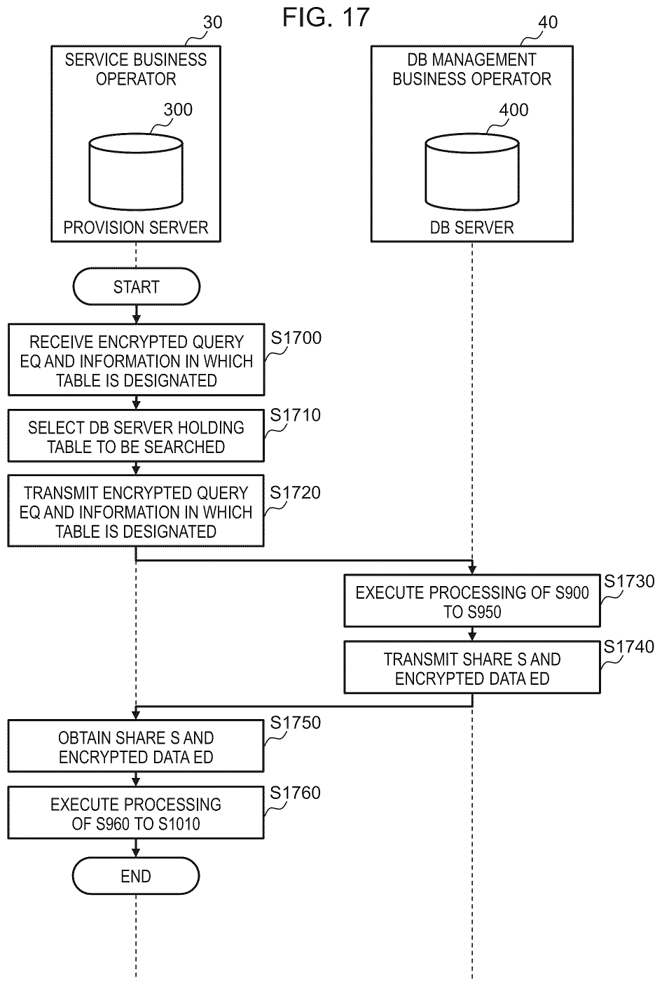

FIG. 17 illustrates a procedure in which the provision server 300 is requested to search for one encrypted query EQ in the search phase of the confidential computation system 1000 and transmits output data in cooperation with the DB server 400.

In step S1700, the control unit of the provision server 300 executes processing of receiving, via the input unit 300B, the encrypted query EQ and the information in which the table is designated. Accordingly, the information is acquired. When the processing of step S1700 is completed, the control unit of the provision server 300 proceeds to step S1710.

In step S1710, the control unit of the provision server 300 executes processing of selecting the DB server 400 holding the designated table by the processing unit 300G. Accordingly, the DB server 400 holding the designated table is selected. When the processing of step S1710 is completed, the control unit of the provision server 300 proceeds to step S1720.

In step S1720, the control unit of the provision server 300 executes, via the output unit 300H, processing of transmitting, to the DB server 400 selected in step S1710, the encrypted query EQ and the information in which the table is designated. Accordingly, the encrypted query EQ and the information in which the table is designated are transmitted to the DB server 400. When the processing in step S1720 is completed, the control unit of the provision server 300 waits until the share S and the encrypted data ED are received from the DB server 400 in step S1750.

In step S1730, the DB server 400 sequentially executes the processing of steps S900 to S950 in FIG. 9 performed by the provision server 300 in Embodiment 1. That is, as processing equivalent to step S900 of FIG. 9, the control unit of the DB server 400 executes processing of receiving, via the input unit 400B, the encrypted query EQ and the information in which the table is designated. Accordingly, the information is acquired. Next, as processing equivalent to step S910 of FIG. 9, the control unit of the DB server 400 executes processing of selecting a table to be searched according to the designated information. Accordingly, the table to be searched is selected. Next, as processing equivalent to step S920 of FIG. 9, the control unit of the DB server 400 executes, via the input unit 400B, processing of reading the search index from the selected table. Accordingly, the search index is read. Next, as processing equivalent to step S930 in FIG. 9, the control unit of the DB server 400 executes processing of determining whether there is an encrypted word EW that has not been compared yet in the search index read by the processing equivalent to step S920. If it is determined in the processing that all the encrypted words EW of the search index have been compared and there is no encrypted word EW that has not been compared yet (step S930: YES), the processing proceeds to step S1740. On the other hand, if it is determined in the processing that there is an encrypted word EW that has not been compared yet in the search index (step S930: NO), the processing proceeds to the same processing as step S940. Next, as processing equivalent to step S940 of FIG. 9, the control unit of the DB server 400 executes, via the input unit 400B, processing of reading the encrypted word EW that has not been read yet from the search index. Accordingly, the encrypted word EW that has not yet been read is read from the search index. Next, as processing equivalent to step S950 of FIG. 9, the control unit of the DB server 400 executes processing of comparing the encrypted query EQ with the encrypted word EW by using the comparison function of the searchable encryption by the comparison unit 400D. If the comparison result indicates a match, the embedded share S is decrypted. Accordingly, the encrypted query EQ is compared with the encrypted word EW, and if the comparison result indicates a match, the embedded share S is decrypted. When the series of processing is completed, the control unit of the DB server 400 proceeds to step S1740.

In step S1740, the control unit of the DB server 400 executes, via the output unit 400E, processing of transmitting, to the provision server 300, the share S and the encrypted data ED related to the encrypted word EW whose comparison result is determined as a match. Accordingly, the share S and the encrypted data ED are transmitted to the provision server 300. When the processing in step S1740 is completed, the processing performed by the DB server 400 in the processing illustrated in the flowchart of FIG. 17 ends.

In step S1750, the control unit of the provision server 300 executes processing of receiving, via the input unit 300B, the share S and the encrypted data ED transmitted by the DB server 400 in step S1740. Accordingly, the share S and the encrypted data ED are acquired. When the processing of step S1750 is completed, the control unit of the provision server 300 proceeds to step S1760.

In step S1760, the provision server 300 sequentially executes the processing of steps S960 to S1010 in FIG. 9 performed in Embodiment 1. That is, processing equivalent to step S960 of FIG. 9, the control unit of the provision server 300 executes processing of determining whether t or more shares S are collected by the reconstruction unit 300E. If it is determined in the processing that t or more shares S are collected (step S960: YES), the processing proceeds to the same processing as step S970. On the other hand, if it is determined in the processing that t or more shares S are not collected (step S960: NO), the processing illustrated in the flowchart of FIG. 17 is ended. Next, as processing equivalent to step S970 of FIG. 9, the control unit of the provision server 300 executes processing of inputting t shares S and reconstructing the data key DK by the reconstruction unit 300E. Accordingly, the data key DK is reconstructed. Next, as processing equivalent to step S980 of FIG. 9, the control unit of the provision server 300 executes, via the input unit 300B, processing of reading all the encrypted data ED related to the encrypted word EW whose comparison result is determined as a match. Accordingly, all the encrypted data ED is read. When the processing of step S980 is completed, the control unit of the provision server 300 proceeds to step S990. Next, as processing equivalent to step S990 of FIG. 9, the control unit of the provision server 300 executes processing of using the data key DK to decrypt all the read encrypted data ED into the plaintext data PD by the decryption unit 300F. Accordingly, all the encrypted data ED is decrypted into the plaintext data PD. Next, as processing equivalent to step S1000 in FIG. 9, the control unit of the provision server 300 executes processing of performing any computation based on the plaintext data PD decrypted by the processing equivalent to step S990 by the processing unit 300G, and creating the data for output. As an example of the computation, the processing unit 300G may calculate a statistic of the plaintext data PD and create the data for output. For example, the processing unit 300G may analyze the plaintext data PD by machine learning and create the data for output. For example, the processing unit 300G may create an AI model obtained by learning the plaintext data PD and use the AI model as the data for output. For example, the processing unit 300G may perform conversion such as format processing or anonymization processing on the plaintext data PD to create the data for output. Accordingly, the data for output is created. Next, as the same processing as in step S1010 in FIG. 9, the control unit of the provision server 300 executes, via the output unit 300H, processing of transmitting the data for output created by the same processing as in step S1000. Accordingly, the data for output is transmitted. When the processing equivalent to step S1010 is completed, the control unit of the provision server 300 ends the processing illustrated in the flowchart of FIG. 17.

The processing described above is a procedure of comparing one encrypted query EQ in the provision server 300 with the encrypted word EW in the search index. The same processing can be performed when any number of encrypted queries EQ are compared with any number of encrypted words EW.

The procedure of the processing described above is an example, and the processing order and the processing content may be changed as necessary.

In the decryption, other encryption methods such as public key encryption and searchable encryption may be used instead of the symmetric key encryption.

By the processing described above, the output unit 200C of the analyzer 200 transmits the encrypted query EQ transmitted for the search request and the information in which the table is designated (step S1621), and the input unit 300B of the provision server 300 receives, via the network 600, the encrypted query EQ and the information in which the table is designated. The provision server 300 requests the DB server 400 holding the designated table to perform the search again (step S1622), the comparison unit 400D of the DB server 400 compares the encrypted word EW in the search index of the designated table in the database 400A with the encrypted query EQ, and the decryption unit (not illustrated) of the DB server 400 decrypts the share S from the comparison result (step S1623). The output unit 400E of the DB server 400 transmits, to the provision server 300 as a search result, the share S and the encrypted data ED related to the encrypted word EW whose comparison result is determined as a match (step S1624), the provision server 300 transmits a result obtained by processing the search result to the analyzer 200 (step S1625), and the analyzer 200 acquires the result (step S1626).

As described above, in the confidential computation system 1000 according to Embodiment 3, each of organizations represented by the DB server 400 manages an encrypted table, searches a table on the DB server 400 according to an instruction requested via the provision server 300, and when the hit number of the search of the table is a threshold or more, the provision server 300 decrypts the related encrypted data ED into the plaintext data PD, and the computation can be performed.

In the confidential computation system 1000 according to Embodiment 3, the provision server 300 makes an inquiry to the DB server 400 that manages the table in the database 400A instead, so that a processing destination of the analyzer 200 may be only the provision server 300, and a processing load of the analyzer 200 is reduced. The encrypted data ED transmitted from the DB server 400 to the provision server 300 is decrypted as the plaintext data PD only when the hit number of the search is the threshold or more. When the hit number of the search across a plurality of organizations is less than the number determined by the threshold, the encrypted data ED is not decrypted, and the confidentiality is maintained.

The confidential computation system 1000 according to Embodiment 3 has been described above.

The embodiments of the invention described above are summarized as follows.
(1) A confidential computation system 1000 is a system that executes computation related to data representing information in a state where the information is kept confidential by encryption, and includes a registration machine 100, an analyzer 200, and a provision server 300, each of which is a computer at least having a processor 101 and a storage device (102, 103), and which are connected to each other via a network 600 to be capable of performing data communication, in which the registration machine 100 is configured to derive a data key DK by using a plaintext word PW representing a word which is not encrypted, create encrypted data ED obtained by encrypting, by using the derived data key DK, plaintext data PD representing data which is not encrypted, distribute the data key DK to a plurality of shares S, and encrypt the plaintext word PW and the shares S with searchable encryption to create an encrypted word EW, the analyzer 200 is configured to encrypt, with the searchable encryption, a plaintext query PQ representing a query which is not encrypted to create an encrypted query EQ, and the provision server 300 is configured to acquire the created encrypted word EW and the created encrypted data ED to register the encrypted word EW and the created encrypted data ED in a database 300A, acquire the created encrypted query EQ to compare the created encrypted query EQ with the registered encrypted word EW, and acquire the shares S if a comparison result indicates a match, reconstruct, if the number of the acquired shares S is a certain number or more, the data key DK having a correspondence relationship with the plurality of shares S including the certain number or more of the shares S by using the certain number or more of the shares S, and decrypt the encrypted data ED into the plaintext data PD by using the reconstructed data key DK. That is, the confidential computation system 1000 compares the encrypted word EW obtained by encrypting the plaintext word PW with the encrypted query EQ obtained by encrypting the plaintext query PQ, counts the number of evaluations that the encrypted word EW and the encrypted query EQ are the same, and decrypts the encrypted data ED to acquire the plaintext data PD only when the number is a threshold or more. As a result, the confidential computation system 1000 can perform various types of computation on the data (encrypted data ED) representing the information in a state where confidentiality of the encrypted information is secured without disclosing a plaintext more than necessary.
(2) The registration machine 100 encrypts a word key WK and the plaintext word PW to create the encrypted word EW, and the analyzer 200 encrypts a query key QK and the plaintext query PQ to create the encrypted query EQ.
(3) The provision server 300 acquires a share S from the encrypted data ED if the encrypted word EW and the encrypted query EQ are evaluated to be the same, and reconstructs the data key DK from the share S if the number of shares S is a predetermined threshold or more.
(4) The registration machine 100 generates a share S in which the data key DK is embedded by using the plaintext word PW.
(5) The registration machine 100 generates a polynomial P by using the plaintext word PW.
(6) The provision server 300 collects the share S for each of designated tables.
(7) The provision server 300 performs name identification on the plaintext data PD by using a common attribute for each of the tables.
(8) A threshold is set for each of the tables, and the provision server 300 is configured to acquire the share S from the encrypted data ED for each of the tables, and reconstruct confidential information if the number of the shares S is the threshold for each of the tables or more.
(9) The provision server 300 at least includes a first provision server 300a and a second provision server 300b, the first provision server 300a acquires a share S from the encrypted data ED if the encrypted word EW and the encrypted query EQ are evaluated to be the same, and the second provision server 300b reconstructs the data key DK from the share S.

The invention is not limited to the embodiments described above and can be implemented using any component without departing from the gist of the invention.

The embodiments described above are merely examples, and the invention is not limited to the contents thereof as long as the characteristics of the invention are not impaired. Although various embodiments have been described above, the invention is not limited to these contents, and not all of these contents are essential to the solution of the invention. Other aspects conceivable within the scope of the technical idea of the invention are also included within the scope of the invention.

In the drawings described above, control lines and information lines that are considered necessary for description are illustrated, and not all the control lines and information lines necessary for implementation are necessarily illustrated. For example, it may be considered that almost all configurations are actually interconnected.

A disposition form of the functional units of the confidential computation system 1000 described above is merely an example. The disposition form of the functional units can be changed to an optimal disposition form from a viewpoint of performance, processing efficiency, communication efficiency, and the like of hardware and software included in the confidential computation system 1000.

A part or all of the configurations, functions, processing units, processing methods, and the like of the confidential computation system 1000 described above may be implemented by hardware by, for example, designing with an integrated circuit, or may be implemented by software by, for example, a processor 101 interpreting and executing a program for implementing each function. Information such as programs, tables, and files for implementing the functions can be stored in the memory 102, a storage device including the storage 103 such as a hard disk or an SSD, or a recording medium such as an IC card, an SD card, or a digital versatile disc (DVD).

What is claimed is:

1. A confidential computation system that executes computation related to data representing information in a state where the information is kept confidential by encryption, the confidential computation system comprising:
a registration machine, an analyzer, and a provision server, each of which is a computer at least having a processor and a storage device, and which are connected to each other via a network to be capable of performing data communication, wherein
the registration machine is configured to
derive a data key by using a plaintext word representing a word which is not encrypted,
create encrypted data obtained by encrypting, by using the derived data key, plaintext data representing data which is not encrypted,
distribute the data key to a plurality of shares, and
encrypt the plaintext word and the shares with searchable encryption to create an encrypted word,
the analyzer is configured to
encrypt, with the searchable encryption, a plaintext query representing a query which is not encrypted to create an encrypted query, and
the provision server is configured to
acquire the created encrypted word and the created encrypted data to register the encrypted word and the created encrypted data in a database,
acquire the created encrypted query to compare the created encrypted query with the registered encrypted word, and acquire the shares if a comparison result indicates a match,
reconstruct, if the number of the acquired shares is a certain number or more, the data key having a correspondence relationship with the plurality of shares including the certain number or more of the shares by using the certain number or more of the shares, and
decrypt the encrypted data into the plaintext data by using the reconstructed data key.

2. The confidential computation system according to claim 1, wherein
the registration machine encrypts a word key and the plaintext word to create the encrypted word, and
the analyzer encrypts a query key and the plaintext query to create the encrypted query.

3. The confidential computation system according to claim 1, wherein
the provision server acquires a share from the encrypted data if the encrypted word and the encrypted query are evaluated to be the same, and reconstructs the data key from the share if the number of shares is a predetermined threshold or more.

4. The confidential computation system according to claim 1, wherein
the registration machine generates a share in which the data key is embedded by using the plaintext word.

5. The confidential computation system according to claim 1, wherein
the registration machine generates a polynomial by using the plaintext word.

6. The confidential computation system according to claim 1, wherein
the provision server collects the share for each of designated tables.

7. The confidential computation system according to claim 6, wherein
the provision server performs name identification on the plaintext data by using a common attribute for each of the tables.

8. The confidential computation system according to claim 6, wherein
a threshold is set for each of the tables, and
the provision server is configured to
acquire the share from the encrypted data for each of the tables, and
reconstruct confidential information if the number of the shares is the threshold or more for each of the tables.

9. The confidential computation system according to claim 1, wherein
the provision server at least includes a first provision server and a second provision server,
the first provision server acquires a share from the encrypted data if the encrypted word and the encrypted query are evaluated to be the same, and
the second provision server reconstructs the data key from the share.

10. A confidential computation method that executes computation related to data representing information in a state where the information is kept confidential by encryption, wherein
the confidential computation method is executed by a computation system including a registration machine, an analyzer, and a provision server, each of which is a computer at least having a processor and a storage device, and which are connected to each other via a network to be capable of performing data communication,
the registration machine is configured to at least execute
a process of deriving a data key by using a plaintext word representing a word which is not encrypted,
a process of creating encrypted data obtained by encrypting, by using the derived data key, plaintext data representing data which is not encrypted,
a process of distributing the data key to a plurality of shares, and
a process of encrypting the plaintext word and the shares with searchable encryption to create an encrypted word,
the analyzer is configured to at least execute
a process of encrypting, with the searchable encryption, a plaintext query representing a query which is not encrypted to create an encrypted query, and
the provision server is configured to at least execute
a process of acquiring the created encrypted word and the created encrypted data to register the encrypted word and the created encrypted data in a database,
a process of acquiring the created encrypted query to compare the created encrypted query with the registered encrypted word, and acquiring the shares if a comparison result indicates a match,
a process of reconstructing, if the number of the acquired shares is a certain number or more, the data key having a correspondence relationship with the plurality of shares including the certain number or more of the shares by using the certain number or more of the shares, and
a process of decrypting the encrypted data into the plaintext data by using the reconstructed data key.

11. A computer program, wherein
in a computer system that includes a registration machine, an analyzer, and a provision server, each of which is a computer at least having a processor and a storage device, and which are connected to each other via a network to be capable of performing data communication,
the computer program causes the registration machine to
derive a data key by using a plaintext word representing a word which is not encrypted,
create encrypted data obtained by encrypting, by using the derived data key, plaintext data representing data which is not encrypted,
distribute the data key to a plurality of shares, and
encrypt the plaintext word and the shares with searchable encryption to create an encrypted word,
the computer program causes the analyzer to
encrypt, with the searchable encryption, a plaintext query representing a query which is not encrypted to create an encrypted query, and
the computer program causes the provision server to
acquire the created encrypted word and the created encrypted data to register the encrypted word and the created encrypted data in a database,
acquire the created encrypted query to compare the created encrypted query with the registered encrypted word, and acquire the shares if a comparison result indicates a match,
reconstruct, if the number of the acquired shares is a certain number or more, the data key having a correspondence relationship with the plurality of shares including the certain number or more of the shares by using the certain number or more of the shares, and
decrypt the encrypted data into the plaintext data by using the reconstructed data key.
